(19) United States
(12) Patent Application Publication
(10) Pub. No.: US 2013/0222276 A1
(43) Pub. Date: Aug. 29, 2013

(54) ELECTRONIC DEVICE AND METHOD FOR CONTROLLING ELECTRONIC DEVICE

(71) Applicants: Yongsin KIM, Seoul (KR); Jihwan KIM, Seoul (KR); Kihyung KIM, Seoul (KR); Jihyun KIM, Seoul (KR)

(72) Inventors: Yongsin KIM, Seoul (KR); Jihwan KIM, Seoul (KR); Kihyung KIM, Seoul (KR); Jihyun KIM, Seoul (KR)

(73) Assignee: LG ELECTRONICS INC., Seoul (KR)

(21) Appl. No.: 13/408,871

(22) Filed: Feb. 29, 2012

(51) Int. Cl. G06F 3/041

(52) U.S. Cl. 345/173

(57) ABSTRACT

An electronic device is provided that includes a display unit including a first region and a second region and a control unit configured to receive a first touch stroke through the first region, to receive a second touch stroke through the second region, to generate a third touch stroke corresponding to the first and second touch strokes when a relationship between the first and second touch strokes satisfies to a predetermined condition, and to perform an operation corresponding to the third touch stroke.

### CROSS-REFERENCE TO RELATED APPLICATION

This application claims priority to Korean Patent Application No. ______ filed on ______, the contents of which are herein incorporated by reference in its entirety.

### TECHNICAL FIELD

Embodiments of the present invention are directed to electronic devices that include a display unit dividable into two or more regions by a bending operation and control methods of the electronic devices.

### DISCUSSION OF THE RELATED ART

According to mobility, terminals may be classified into mobile/portable terminals and stationary terminals. The mobile terminals may be classified into handheld terminals and vehicle mount terminals according to users' portability.

As terminals have various functions, such as image or movie capturing, replay of music or movie files, games, reception of broadcasting, etc. the terminals are implemented as multimedia players that may perform such multiple functions.

To support or increase various functions, the terminals may undergo changes in structure or software.

Foldable flexible displays are applied to mobile terminals. Accordingly, there is a need for intuitive user interfaces that allow users to use the flexible displays more easily.

### SUMMARY

Embodiments of the present invention provide an electronic device, which provides a user interface easy for a user to use more intuitively when receiving a touch input from the user through the display unit that is implemented as a flexible display and a control method of the electronic device. Other embodiments of the present invention will be apparent from the detailed description with reference to the accompanying drawings.

According to an embodiment, there is provided an electronic device including a display unit including a first region and a second region and a control unit configured to receive a first touch stroke through the first region, to receive a second touch stroke through the second region, to generate a third touch stroke corresponding to the first and second touch strokes when a relationship between the first and second touch strokes satisfies to a predetermined condition, and to perform an operation corresponding to the third touch stroke.

The predetermined condition is whether a difference between an end time of the first touch stroke and a start time of the second touch stroke is within a predetermined time range.

The predetermined condition is whether a difference between a trace direction of the first touch stroke and a trace direction of the second touch stroke is within a predetermined range.

The predetermined range varies depending on the trace direction of the first touch stroke.

The predetermined condition is whether a start point of the second touch stroke is within a range determined by an end point of the first touch stroke.

The predetermined condition is whether a difference in speed between the first and second touch strokes is within a predetermined range.

A speed of the second touch stroke is a speed obtained when the second touch stroke is positioned near a start point of the second touch stroke.

The predetermined condition is whether a variation in distance of a touching body with respect to the display unit is within a predetermined range, the variation being measured at a least one of an end point of the first touch stroke and a start point of the second touch stroke.

The control unit is configured to generate the third touch stroke so that a start point of the third touch stroke is a start point of the first touch stroke and an end point of the third touch stroke is an end point of the second touch stroke.

The display unit is a touch screen.

The display unit is divided into at least two regions including the first and second regions by bending.

According to an embodiment, there is provided an electronic device including a display unit including at least two regions including first and second regions and a control unit configured to change a position of an object from a first position and a second position according to a first touch stroke input through the first region, to change the position of the object from the second position to a third position after the first touch stroke ends, to receive a second touch stroke through the second region, to determine whether the second touch stroke satisfies a predetermined condition, and when the second touch stroke satisfies the predetermined condition, to change the position of the object from the third position to a fourth position.

When the second touch stroke does not satisfy the predetermined condition, the control unit is configured to change the position of the object from the third position to the second position.

The second position is determined by the first touch stroke.

The fourth position is determined by the second touch stroke.

According to an embodiment, there is provided an electronic device including a display unit including at least two regions including first and second regions and a control unit configured to move a screen image displayed on the display unit according to a first touch stroke input through the first region by a first distance, to move the screen image by a second distance after the first touch stroke ends, to receive a second touch stroke through the second region, to determine whether the second touch stroke satisfies a predetermined condition, and when the second touch stroke satisfies the predetermined condition, to move the screen image by a third distance.

When the second touch stroke does not satisfy the predetermined condition, the control unit is configured to move the screen image by the second distance in an opposite direction of a travelling direction in which the screen image travels according to the first touch stroke.

The first distance is determined by the first touch stroke.

The third distance is determined by the second touch stroke.

According to an embodiment, there is provided an electronic device including a display unit including at least two regions including first and second regions and a control unit configured to perform an operation corresponding to a first touch stroke input through the first region and to disregard a touch input made through the second region while receiving a touch stroke through the first region.

The display unit is divided into the at least two regions including the first and second regions by a bending operation.

The control unit is configured to perform an operation corresponding to the touch stroke when the touch stroke through the first region ends.

According to an embodiment, there is provided an electronic device including a display unit including at least two regions including first and second regions and a control unit configured to receive a first touch input through the first region, to receive a second touch input through the second region, to determine whether a difference between a first time when the first touch input is made and a first time when the second touch input is made is within a predetermined time range, and when the difference between the first time when the first touch input is made and the first time when the second touch input is made is within the predetermined time range, to select one of the first and second touch inputs, wherein the selected touch input has a smaller area than an area of the other touch input, and to perform an operation corresponding to the selected touch input.

The control unit is configured to disregard the other touch input(s) than the selected touch input.

When the difference between the first time when the first touch input is made and the first time when the second touch input is made is not within the predetermined time range, the control unit is configured to perform a first operation corresponding to the first touch input and a second operation corresponding to the second touch input.

According to an embodiment, there is provided an electronic device including a display unit including a state including a bending state and a flat state depending on a degree of bending, wherein when in the bending state, the display unit includes at least two regions including first and second regions and a control unit configured to select one of first and second modes depending on the state of the display unit and to analyze a touch stroke input through the display unit depending on the selected mode, wherein in a case where two different first and second touch strokes are input, the control unit is configured to perform an operation corresponding to a combination of the two touch strokes when the first mode is selected and to perform two operations respectively corresponding to the two touch strokes when the second mode is selected.

The control unit is configured to select the first mode, to determine whether a relationship between the two touch strokes satisfies a predetermined condition, and when the relationship satisfies the predetermined condition, to perform an operation corresponding to a combination of the two touch strokes.

According to the embodiments, the following effects may be provided.

First, in the case that the display unit 151 is in the bending state, when a user attempts to input a touch stroke starting at the first region R1 and ending at the second region R2, the user need not perform a touch input with his finger in contact with the display unit 151 or with the finger remaining in the critical distance from the display unit 151. The user may make a touch input on the display unit 151 which remains in the bent state using his finger to input a desired command to the electronic device 100, thus providing increased convenience.

Second, even when the user does not continue to perform the touch input on the display unit 151 at a bent portion of the display unit 151 when the display unit 151 is in the bending state, the object which is being moved by the first touch stroke input through the first region may be continuously displayed even after the first touch strokes ends, and according to whether the second touch stroke is input through the second region and/or whether the relationship between the first and second touch strokes satisfies the predetermined condition, the position of the object may be selectively changed to a position corresponding to the second touch stroke or corresponding to the end point of the first touch stroke, thereby providing the user with more smooth visual feedback.

Third, even when the user does not continue to perform the touch input on the display unit 151 at a bent portion of the display unit 151 when the display unit 151 is in the bending state, the screen S which is being moved by the first touch stroke input through the first region may be continuously displayed even after the first touch strokes ends, and according to whether the second touch stroke is input through the second region and/or whether the relationship between the first and second touch strokes satisfies the predetermined condition, the screen S may be selectively moved further to a position corresponding to the second touch stroke or back to a position corresponding to the end point of the first touch stroke, thereby providing the user with more smooth visual feedback.

Fourth, when the user desired to input a touch stroke only on the first region but unintentionally ended up making a touch input on the second region as well, the electronic device 100 may determine whether the touch input on the second region does not conform to the user's intention. If the determination result shows that the touch input on the second region is not his intention, the electronic device 100 may perform only an operation corresponding to the touch stroke input on the first region while disregarding the touch input on the second region. Accordingly, when touch input is made on the display which is in the bending state, more user convenience can be achieved.

Finally, When the display unit 151 is in the flat state and/or the degree of bending of the display unit 151 does not conform to the predetermined reference, the electronic device 100 analyzes touch inputs by existing methods but if the degree of bending of the display unit 151 conforms to the predetermined reference, the display unit 151 analyzes touch inputs based on a touch algorithm implemented by a combination of at least one or more of the first to fifth embodiments suggested to address the problems that may occur upon touch input when the display unit 151 is in the bending state. Thus, when the display unit 151 is in the flat state, the electronic device 100 may allow the user to perform touch input according to existing methods. Further, when the display unit 151 is in the bending state, the electronic device 100 may allow the user to have a further improved touch interface.

### BRIEF DESCRIPTION OF THE DRAWINGS

The embodiments of the present invention will become readily apparent by reference to the following detailed description when considered in conjunction with the accompanying drawings wherein:

FIG. 1 is a block diagram illustrating an electronic device according to an embodiment of the present invention;

FIG. 2 is a view illustrating an electronic device having a flexible display according to an embodiment of the present invention;

FIG. 3 is a view illustrating an electronic device having a flexible display according to an embodiment of the present invention;

FIG. 4 is a cross sectional view taken along line I-I′ of (a) of FIG. 2;

FIGS. 5 to 9 are views illustrating some situations and/or environments to which the embodiments of the present invention;

FIG. 10 is a flowchart illustrating a method of controlling an electronic device according to the first embodiment of the present invention;

FIG. 11 is a view illustrating a predetermined condition for the relationship in time between the first touch stroke and the second touch stroke according to the first embodiment;

FIG. 12 is a view illustrating a predetermined condition for the relationship in trace direction between the first and second touch strokes according to the first embodiment;

FIG. 13 is a view illustrating a predetermined condition for the relationship in position between the first and second touch strokes according to the first embodiment;

FIG. 14 is a view illustrating a predetermined condition for the relationship in speed between the first and second touch strokes according to the first embodiment;

FIG. 15 is a view illustrating a predetermined condition for the proximity distance of the finger and the display unit upon input of the first and second touch strokes according to the first embodiment;

FIGS. 16 to 18 illustrate various methods of generating the virtual third touch stroke according to the first embodiment;

FIG. 19 is a flowchart illustrating a method of controlling an electronic device according to the second embodiment of the present invention;

FIGS. 20 to 24 illustrate a method of controlling an electronic device according to the second embodiment;

FIG. 25 is a flowchart illustrating a method of controlling an electronic device according to the third embodiment;

FIGS. 26 to 31 illustrate a method of controlling an electronic device according to the third embodiment;

FIG. 32 is a flowchart illustrating a method of controlling an electronic device according to the fourth embodiment;

FIGS. 33 and 34 illustrate a method of controlling an electronic device according to the fourth embodiment;

FIG. 35 is a flowchart illustrating a method of controlling an electronic device according to the fifth embodiment;

FIGS. 36 and 37 are views for describing an environment and/or situation where the control method according to the fifth embodiment may apply;

FIGS. 38 to 42 illustrate a method of controlling an electronic device according to the fifth embodiment; and

FIG. 43 is a flowchart illustrating a method of controlling an electronic device according to the sixth embodiment.

### DESCRIPTION OF THE EMBODIMENTS

The embodiments of the present invention will be apparent from the detailed description with reference to the accompanying drawings. However, the embodiments of the present invention are not limited thereto, and diverse variations or modifications to the embodiments may be made.

In the drawings, the thickness of the layer or region may be exaggerated for clarity. It will be understood that when an element or layer is referred to as being “on” another element or layer, it can be directly on the other element or layer or intervening elements or layers may be present. Like numbers may refer to like or similar elements throughout the specification and the drawings.

When determined to render the gist of the present invention unnecessarily unclear, the specific description on known functions or configurations will be omitted. As used herein, the number (for example, first, second, . . . ) is used only to distinguish one component from another.

In the following description, suffixes “module” and “unit” are given to components of the mobile terminal in consideration of only facilitation of description and do not have meanings or functions discriminated from each other.

As used herein, the electronic device may include a stationary type terminal, such as a digital TV or a desktop computer, as well as a mobile terminal, such as a cellular phone, a smart phone, a laptop computer, a digital broadcast terminal, a PDA (Personal Digital Assistant), a PMP (Portable Multimedia Player), or a navigation system.

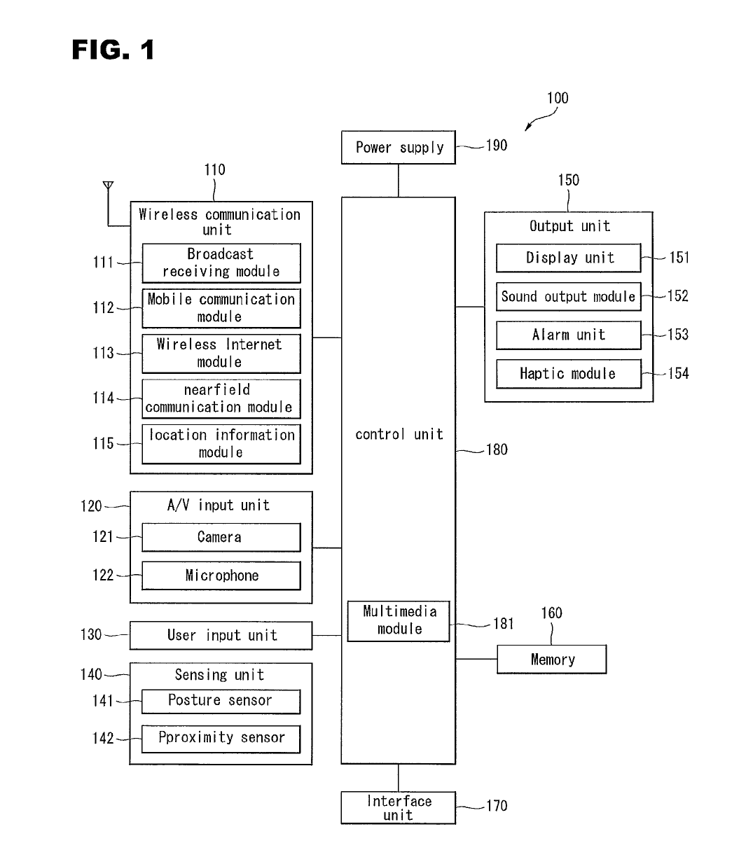

FIG. 1 is a block diagram illustrating an electronic device according to an embodiment of the present invention.

The electronic device 100 includes a wireless communication unit 110, an A/V (Audio/Video) input unit 120, a user input unit 130, a sensing unit 140, an output unit 150, a memory 160, an interface unit 170, a control unit 180, and a power supply 190. The components shown in FIG. 1 are not necessary, and according to an embodiment, more or less components may be included in the electronic device 100.

Hereinafter, each component is described more specifically.

The wireless communication unit 110 may include one or more modules that enables wireless communication between the electronic device 100 and a wireless communication system or between the electronic device 100 and a network in which the electronic device 100 is positioned. For instance, the electronic device 100 may include a broadcast receiving module 111, a mobile communication module 112, a wireless Internet module 113, a nearfield communication module 114, and a location information module 115.

The broadcast receiving module 111 receives broadcast signals and/or broadcast-related information from an external broadcast management server through broadcast channels.

The broadcast channels include satellite channels or terrestrial channels. The broadcast management server may include a server that generates and transmits broadcast signals and/or broadcast-related information or receives pre-generated broadcast signals and/or broadcast-related information and transmits the signals and information to a terminal. The broadcast signals may include TV broadcast signals, radio broadcast signals, data broadcast signals, as well as broadcast signals including combinations of TV broadcast signals or radio broadcast signals and data broadcast signals.

The broadcast-related information may include information relating to broadcast channels, broadcast programs or broadcast service providers. The broadcast-related information may be provided through a mobile communication network and may be received through the mobile communication module 112.

Various types of broadcast-related information may be provided, such as EPG (Electronic Program Guide) of DMB (Digital Multimedia Broadcasting) or ESG (Electronic Service Guide) of DVBH (Digital Video Broadcast Handheld).

The broadcast receiving module 111 receives broadcast signals (e.g., digital broadcast signals) through various broadcast systems, such as, for example, DMBT (Digital Multimedia Broadcasting Terrestrial), DMBS (Digital Multimedia Broadcasting Satellite), Media FLO (Media Forward Link Only), DVBH (Digital Video Broadcast Handheld), ISDBT (Integrated Services Digital Broadcast Terrestrial), or other digital broadcast systems. The broadcast receiving module 111 may be configured to fit for any other broadcast system providing broadcast signals as well as the above-listed digital broadcast systems.

The broadcast signals and/or broadcast-related information received through the broadcast receiving module 111 may be stored in the memory 160.

The mobile communication module 112 transmits and receives wireless signals to/from at least one of a base station, an external terminal, and a server over a mobile communication network. The wireless signals may include voice call signals, video call signals, various types of data based on transmission/reception of text/multimedia messages.

The wireless Internet module 113 may include modules that can access the Internet wirelessly. The wireless Internet module 113 may be provided inside or outside the electronic device 100. Various types of wireless technologies may be used, such as WLAN (Wireless LAN) (WiFi), Wibro (Wireless broadband), Wimax (World Interoperability for Microwave Access), or HSDPA (High Speed Downlink Packet Access).

The nearfield communication module 114 may include modules for near-field communication. Various near-field communication technologies may be employed, such as Bluetooth, RFID (Radio Frequency Identification), IrDA (infrared Data Association), UWB (Ultra Wideband), ZigBee, or WiHD, WiGig.

The location information module 115 may include a module for identifying a position of the electronic device or for obtaining the information on the position. A representative example of the location information module 115 includes a GPS (Global Position System) module. The GPS module 115 may yield three-dimensional location information based on the longitude, latitude, and altitude of one position (object) at one time by obtaining information on distances between the position (object) and three or more satellites and information on time when the distance information is obtained followed by triangulation. Further, the location information module 115 may obtain information on the position and time using three satellites and correct the obtained information using another satellite. The location information module 115 may produce the current position in real time and calculate the speed information using the current position.

Referring to FIG. 1, the A/V input unit 120 may include a camera 121 and a microphone 122 to receive audio or video signals. The camera 121 processes picture frames such as still images or video images obtained by an image sensor in a video call mode or image capturing mode. The processed picture frames may be displayed on the display unit 151.

The picture frames processed by the camera 121 may be stored in the memory 160 or externally transmitted through the wireless communication unit 110. Two or more cameras 121 may be provided depending on configuration of the terminal.

The microphone 122 receives external sound signals in a call mode, recording mode, or voice recognition mode and process the received signals into electrical sound data. In the case of the call mode, the sound data may be converted into transmittable form and output to a mobile base station through the mobile communication module 112. The microphone 122 may include various noise cancelling algorithms to eliminate noise that is created while receiving external sound signals.

The user input unit 130 generates input data for a user to control the operation of the terminal. The user input unit 130 may include a key pad, a dome switch, a touch pad (resisitive/capacitive), jog wheel, or jog switch.

The sensing unit 140 may sense the current state of the electronic device 100, such as the opening/closing state of the electronic device 100, position of the electronic device 100, presence or absence of user's contact, orientation of the electronic device 100, or acceleration/deceleration of the electronic device 100 and generates sensing signals for controlling the operation of the electronic device 100. For instance, in the case that the electronic device 100 is a sliding phone, the sensing unit 140 may sense whether to open or close the sliding phone. Further, the sensing unit 140 may also sense whether the power supply 190 supplies power or whether the interface unit 170 is coupled with an external device. The sensing unit 140 may include a posture sensor 141 and/or proximity sensor 142.

The output unit 150 is provided to generate visual, audible, or tactile outputs. The output unit 150 may include a display unit 151, a sound output module 152, an alarm unit 152, and a haptic module 154.

The display unit 151 displays information processed by the electronic device 100. For example, in the case that the electronic device 100 is subjected to the call mode, the display unit 151 displays a UI (User Interface) or GUI (Graphic User Interface) relating to call. In the case that the electronic device 100 is in the video call mode or image capturing mode, the display unit 151 displays captured and/or received images or UIs or GUIs.

The display unit 151 may include at least one of a liquid crystal display, a thin film transistor liquid crystal display, an organic light emitting diode display, a flexible display, or a 3D display.

The display unit 151 may be configured in a transparent or light transmissive type, which may be called a “transparent display” examples of which include transparent LCDs. The display unit 151 may have a light-transmissive rear structure in which a user may view an object positioned behind the terminal body through an area occupied by the display unit 151 in the terminal body.

According to an embodiment, two or more display units 151 may be included in the electronic device 100. For instance, the electronic device 100 may include a plurality of display units 151 that are integrally or separately arranged on a surface of the electronic device 100 or on respective different surfaces of the electronic device 100.

The display unit 151 may be logically divided into two or more regions.

When the display unit 151 and a sensor sensing a touch (hereinafter, referred to as a “touch sensor”) are layered (this layered structure is hereinafter referred to as a “touch sensor”), the display unit 151 may be used as an input device as well as an output device. The touch sensor may include, for example, a touch film, a touch sheet, or a touch pad.

The touch sensor may be configured to convert a change in pressure or capacitance, which occurs at a certain area of the display unit 151, into an electrical input signal. The touch sensor may be configured to detect the pressure exerted during a touch as well as the position or area of the touch.

Upon touch on the touch sensor, a corresponding signal is transferred to a touch controller. The touch controller processes the signal to generate corresponding data and transmits the data to the control unit 180. By doing so, the control unit 180 may recognize the area of the display unit 151 where the touch occurred.

The proximity sensor 142 may be positioned in an inner area of the electronic device 100, which is surrounded by the touch screen, or near the touch screen. The proximity sensor 142 refers to a sensor that detects an object approaching a predetermined detection surface or present near the detection surface without physical contact using electromagnetic fields or infrared beams. The proximity sensor 142 has longer lifespan than a contact-type sensor and has more availability.

The proximity sensor 142 may include, but not limited to, a transmissive opto-electrical sensor, a direct reflective opto-electrical sensor, a mirror reflective opto-electrical sensor, a high frequency oscillating proximity sensor, a capacitive proximity sensor, a magnetic proximity sensor, or an IR proximity sensor.

If the touch screen is of a capacitive type, the proximity sensor 142 may detect the approach of a pointer depending on a variation of an electric field that occurs as the point gets close. The touch screen (touch sensor) may be classified as the proximity sensor.

Hereinafter, for ease of description, when a point is positioned near the touch screen while not in contact with the touch screen and it may be recognized that the point is positioned on the touch screen, it is represented as “proximity touch”. When the point actually contacts the touch screen, it is represented as “contact touch”. The position where the proximity touch to the point is done on the touch screen refers to a position where the pointer vertically corresponds to the touch screen when the pointer is subjected to the proximity touch. However, when the proximity touch need not be distinguished from the contact touch, the “touch” or “touch input” may refer to either an input by the proximity touch or an input by the contact touch.

The proximity sensor 142 senses a proximity touch and proximity touch pattern (for example, distance, direction, speed, time, position, or travelling state of the proximity touch). Information corresponding to the sensed proximity touch operation and proximity touch pattern may be displayed on the touch screen.

The sound output module 152 may output audio data received from the wireless communication unit 110 in a call signal receiving mode, call mode, or recording mode, voice recognition mode, or broadcast receiving mode or stored in the memory 160. The sound output module 152 outputs sound signals relating to functions performed in the electronic device 100 (for example, signalling call signal reception or message reception). The sound output module 152 may include a receiver, a speaker, or a buzzer.

The alarm unit 153 outputs signals for signalling an event occurring in the electronic device 100. The event may include reception of call signals or messages, entry of key signals, or touch input. The alarm unit 153 may also output signals for signalling occurrence of an event, for example, by vibration which is of other types than video or audio signals. The video or audio signals may be output through the display unit 151 or the sound output module 152.

The haptic module 154 generates various tactile effects that may be sensed by a user. A representative example of a tactile effect generated by the haptic module 154 includes vibration. The strength or pattern of vibration generated by the haptic module 154 may be controlled. For example, different types of vibration may be mixed and output or sequentially output.

The haptic module 154 may generate an effect coming from a stimulus made by a pin array moving perpendicular to the contact skin surface, an effect coming from a stimulus by jet or suction force of air through an inlet or suction port, an effect coming from a stimulus created when a skin surface is rubbed, an effect coming from a stimulus made by contact with an electrode, an effect coming from a stimulus by an electrostatic force, or an effect coming from reproduction of warm or cool feeling using a heat absorption or generation element.

The haptic module 154 may transfer the tactile effects through a direct contact and may be configured to provide tactile effects through muscle sense of a user's finger or arm. Two or more haptic modules 154 may be provided depending on configuration of the electronic device 100.

The memory 160 may store a program for operation of the control unit 180 and may temporarily store input/output data (for example, phone books, messages, still images, or videos). The memory 160 may store data relating to various patterns of vibration and sounds that are output when touch input is made on the touch screen.

The memory 160 may include at least one storage medium of flash memory types, hard disk types, multimedia card micro types, card type memories (e.g., SD or XD memories), RAMs (Random Access Memories), SRAM (Static Random Access Memories), ROMs (Read-Only Memories), EEPROMs (Electrically Erasable Programmable Read-Only Memories), PROM (Programmable Read-Only Memories), magnetic memories, magnetic discs, and optical discs. The electronic device 100 may operate in association with a web storage performing a storage function of the memory 160 over the Internet.

The interface unit 170 functions as a path between the electronic device 100 and any external device connected to the electronic device 100. The interface unit 170 receives data or power from an external device and transfers the data or power to each component of the electronic device 100 or enables data to be transferred from the electronic device 100 to the external device. For instance, the interface unit 170 may include a wired/wireless headset port, an external recharger port, a wired/wireless data port, a memory card port, a port connecting a device having an identification module, an audio I/O (Input/Output) port, a video I/O port, and an earphone port.

The identity module is a chip storing various types of information to authenticate the authority for using the electronic device 100 and may include a user identity module (UIM), a subscriber identity module (SIM), a universal subscriber identity module (USIM), or the like. A device having the identity module (hereinafter, “identity device”) may be implemented as a smart card so that the identity device may be connected to the electronic device 100 through a port.

The interface unit may serve as a path through which power is supplied from an external cradle to the electronic device 100 when the cradle is connected to the electronic device 100 or a path through which various command signals are supplied from the cradle to the electronic device 100 by a user. The various command signals and the power from the cradle may function as signals that allow the user to notice that the electronic device 100 is correctly coupled with the cradle.

The control unit 180 controls the overall operation of the electronic device 100. For example, the control unit 180 performs control and process relating to voice call, data communication, or video call. The control unit 180 may include a multimedia module 181 for playing multimedia. The multimedia module 181 may be implemented in the control unit 180 or may be provided separately from the control unit 180.

The control unit 180 may perform pattern recognition process that allows handwriting or drawing on the touch screen to be recognized as text or images.

The power supply 190 receives external/internal power under the control of the control unit 180 and feeds the power to other components.

The embodiments herein may be implemented in software, hardware, or a combination thereof, and may be recorded in a recording medium that may be read b a computer or its similar device.

When implemented in hardware, the embodiments may be implemented as at least one of ASICs (application specific integrated circuits), DSPs (digital signal processors), DSPDs (digital signal processing devices), PLDs (programmable logic devices), FPGAs (field programmable gate arrays, processors, controllers, microcontrollers, microprocessors, or electrical units for performing the functions.

When implemented in software, the processes, functions, or the embodiments may be implemented together with a separate software module that may perform at least one function or operation. The software code may be implemented as a software application that has been written in proper program language. The software code may be stored in the memory 160 and executed by the control unit 180.

The electronic device 100 may include the display unit 151 implemented as a flexible display as described above. The flexible display refers to a display that is made of a flexible material and is bendable. In other words, the flexible display has the characteristics of existing flat displays but may be bent, warped, or rolled up like paper. The flexible display is thin and not easily broken. This flexible display may be also referred to as a ‘bendable display’.

The flexible display may be produced using technologies, such as TFT LCD, organic EL (OLED), electrophoretic, or LITI (Laser Induced Thermal Image) technologies.

E-paper may be implemented as a flexible display. E-paper is a display device having the characteristics of general paper and ink. In contrast to typical flat displays requiring a backlight for illumination, E-paper devices do not require a separate backlight and uses reflected light like general paper. Once displayed, an image and/or text may remain displayed even without being additionally fed power.

### A. Thin and Lightweight Flexible Displays May be More Advantageous for Mobile Terminals.

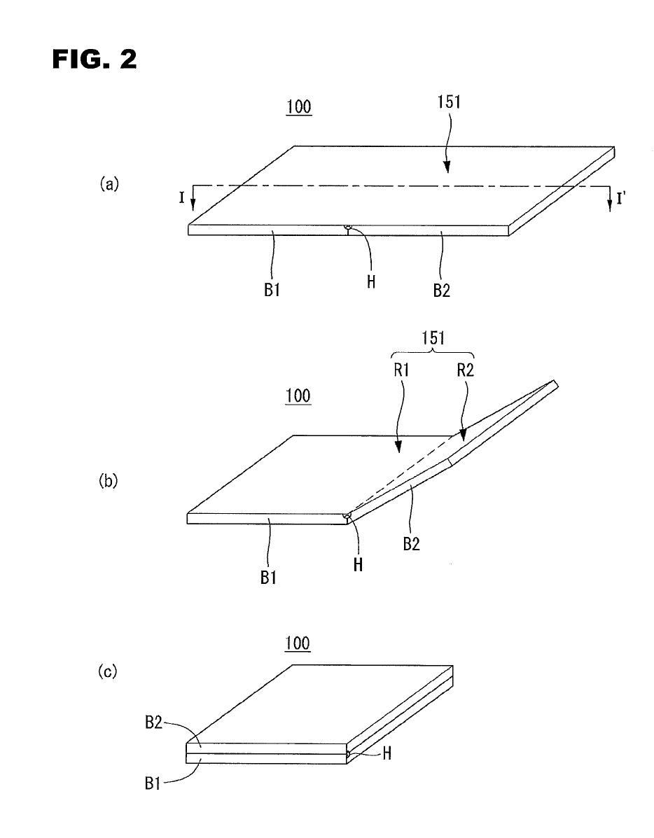

FIG. 2 is a view illustrating an electronic device having a flexible display according to an embodiment of the present invention.

The electronic device has been schematically illustrated for ease of description, and according to an embodiment, other components may be added thereto.

Referring to FIG. 2, the electronic device 100 includes two bodies B1 and B2.

The display unit 151 which is implemented as a flexible display may be provided on one of the bodies B1 and B2. Two flexible displays which are physically discerned from each other may be provided on the respective bodies B1 and B2. Alternatively, one flexible display 151 may be provided on the bodies B1 and B2.

The two bodies B1 and B2 are connected to each other via a hinge H. One of the two bodies B1 and B2 is rotatably connected to the other through the hinge H, for example, in a clamshell type.

(a) of FIG. 2 illustrates an example where the two bodies B1 and B2 are fully unfolded. Hereinafter, a state where the bodies B1 and B2 are fully unfolded as shown in (a) of FIG. 2 is simply referred to as a “flat state”.

(b) of FIG. 2 illustrates an example where one of the two bodies B1 and B2 is slightly rotated so that the bodies are bent with each other, and (c) of FIG. 2 illustrates an example where the two bodies B1 and B2 are completely folded. Hereinafter, a state where the two bodies B1 and B2 are bent as shown in (b) of FIG. 2 is referred to as a “bending state”, and a state where the two bodies are fully folded is referred to as a “folded state”.

As the bodies B1 and B2 turn the flat state into the bending state, the flexible display 151 may be bent as well.

According to whether 151 is fully unfolded or bent, the phrase “flat state” or “bending state” may be used as described above. For example, when the display unit 151 is situated as in (a) FIG. 2, it may be represented that “the display unit 151 is in the flat state” or that “the display unit 151 has the flat state”. When the display unit 151 is situated as in (b) or (c) of FIG. 2, it may be represented that “the display unit 151 is in the bending state” or that “the display unit 151 has the bending state”.

Although two bodies are rotatably coupled to each other as shown in FIG. 2, the embodiments of the present invention are not limited thereto. According to an embodiment, three or more bodies may be included in the electronic device 100 so that one body may be rotatably coupled to the adjacent bodies.

According to an embodiment, when the display unit 151 turns the flat state into the bending state, the display unit 151 may be divided into two or more regions. Where the display unit 151 is divided into the two or more regions may depend on the bending position of the display unit 151. For example, in the case that as shown in (b) of FIG. 2, the electronic device 100 has two bodies B1 and B2 which are bent with respect to the hinge H, the display unit 151 may be logically divided into first and second regions R1 and R2. Although not shown, if the display unit 151 is bent at two positions, the display unit 151 may be divided into three regions, and if bent at three positions, the display unit 151 may be divided into four regions.

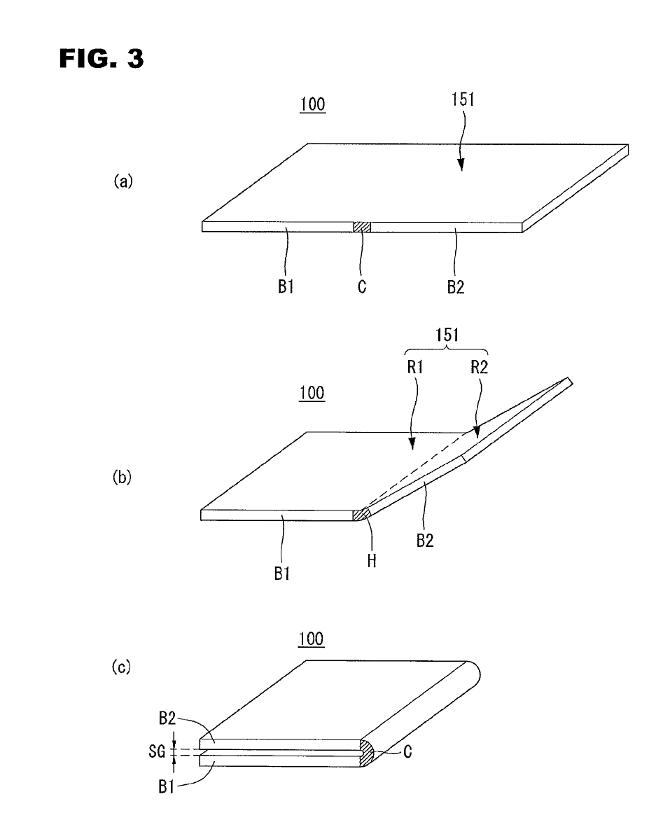

FIG. 3 is a view illustrating an electronic device having a flexible display according to an embodiment of the present invention.

Referring to FIG. 3, on the contrary to what is illustrated in FIG. 2, the first and second bodies B1 and B2 may be connected to each other via a connecting portion C. The connecting portion C may be formed of a flexible material which may be bent as shown in FIG. 3. When the first and second bodies B1 and B2 are fully folded as the folded state, a gap SG may occur between the bodies B1 and B2. For example, in the folded state, the bodies B1 and B2 may remain spaced from each other. At least portions (e.g., both ends) of the bodies B1 and B2 may contact each other.

Hereinafter, unless stated otherwise, the bodies B1 and B2 of the electronic device 100 are connected to each other via the hinge H as shown in FIG. 2. However, this is merely an example, and it is apparent to one of ordinary skill that the bodies may be coupled to each other via the connecting portion C as shown in FIG. 3.

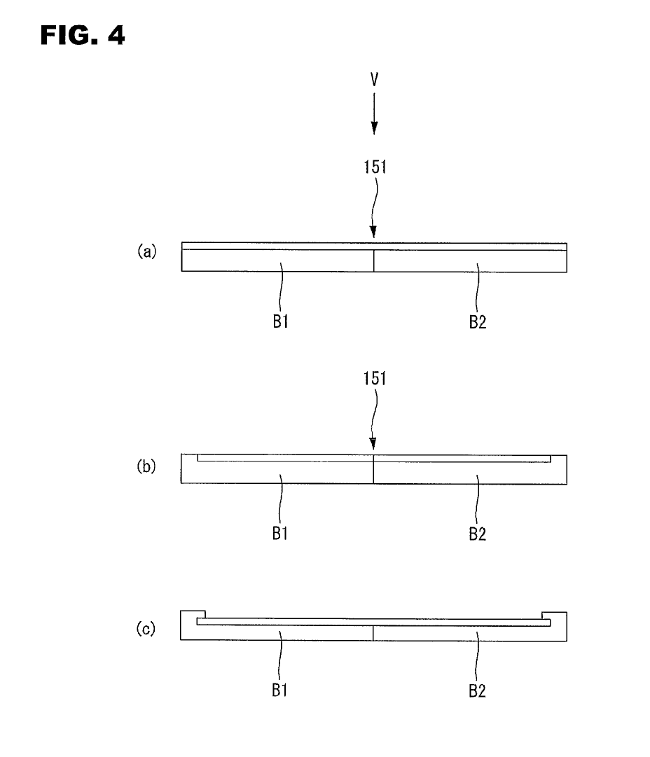

FIG. 4 is a cross sectional view taken along line I-I′ of (a) of FIG. 2. Referring to FIG. 4, the bodies B1 and B2 and the thickness of each layer of the display unit 151 have been exaggerated, and according to an embodiment, each layer may be thicker or thinner. Also, the relative thickness of each layer may differ from what is shown. For example, it is illustrated that the thickness of the display unit 151 is less than the thickness of each body B1 or B2, but according to an embodiment, each body may be thicker in thickness than the display unit 151.

According to an embodiment, the electronic device 100 may be configured so that the area of each body B1 or B2 is the same as the area of the display unit 151 as the electronic device 100 is viewed in the direction V indicated in (a) of FIG. 4. Alternatively, the electronic device 100 may be configured so that the area of each body B1 or B2 is larger than the area of the display unit 151 as shown in (b) and (c) of FIG. 4.

According to an embodiment, an edge portion of each body B1 or B2 may be protruded toward the display unit 151 as shown in (b) of FIG. 4, or as shown in (c) of FIG. 4, the edge portion may be extended in a horizontal direction to cover a side of the display unit 151.

Although not shown, other components may intervene between each body B1 or B2 and the display unit 151, or according to an embodiment, other components may be arranged on the display unit 151. Other components may be provided on the bottom surface of the body B1 or B2.

The electronic device 100 may sense a state of the display unit 151. For this purpose, the electronic device 100 may include a sensor that may sense whether the display unit 151 is bent (in the bending state) or unfolded (in the flat state) (hereinafter, “whether to be bent”). The sensor may sense a location in the display unit 151 where the display unit 151 is bent (hereinafter, referred to as a “bent location”) and may sense how much the display unit 151 is folded (hereinafter, referred to as a “degree of bending”). The degree of bending may be measured as an angle between the bodies B1 and B2.

The sensor sensing whether the display unit 151 is bent may be provided within the flexible display. One or more sensors may be provided. If two or more sensors are provided, the sensors may be arranged along at least one edge of the display spaced apart from each other.

To sense whether the display unit 151 is bent, sensors may be provided at the two bodies B1 and B2.

Hereinafter, for ease of description, the sensor which sense whether the flexible display is bent is referred to as a “bending sensor”. According to, but not limited to, an embodiment, the degree of bending and/or bent location may be sensed through electric signals.

The electronic device 100 may include an inclination sensor to sense a posture of the display unit 151 (also referred to as an “inclined state”). To sense the inclined state of each of regions divided when the display unit 151 is bent, the electronic device 100 may include a plurality of inclination sensors. For example, a plurality of inclination sensors may be provided at a side of each region, or may be provided at body B1 or B2 but not at the display unit 151.

The inclination sensor may include at least one of a gyroscope, an accelerometer, or a magnetic sensor, and/or a combination thereof.

Specifically, when including a gyroscope, the inclination sensor may obtain rotation speeds or angular speeds of the display unit 151 and/or the regions of the display unit 151 as the display unit 151 and/or the regions of the display unit 151 rotate respective of the axis. When including an accelerometer, the inclination sensor may obtain accelerations of the display unit 151 and/or the regions of the display unit 151 as the display unit 151 and/or the regions of the display unit 151 are on the move. When including a magnetic sensor, the inclination sensor may obtain orientations of the display unit 151 and/or the regions of the display unit 151 as if a compass does.

Based on at least one of the angular speeds obtained by the gyroscope, the gravity accelerations obtained by the accelerometer, and the orientations of the display unit 151 and/or the regions of the display unit 151, the control unit 180 may obtain information on movements of the display unit 151 and/or the regions of the display unit 151. For example, when the display unit 151 and/or the regions of the display unit 151 rotate with respect to an axis perpendicularly crossing the display unit 151 and/or the regions of the display unit 151, the control unit 180 may obtain inclined states of the display unit 151 and/or the regions of the display unit 151, which include degrees, speeds, and directions of inclination of the display unit 151 and/or the regions of the display unit 151.

Hereinafter, situations and/or environments to which the embodiments of the present invention may apply will be described in greater detail.

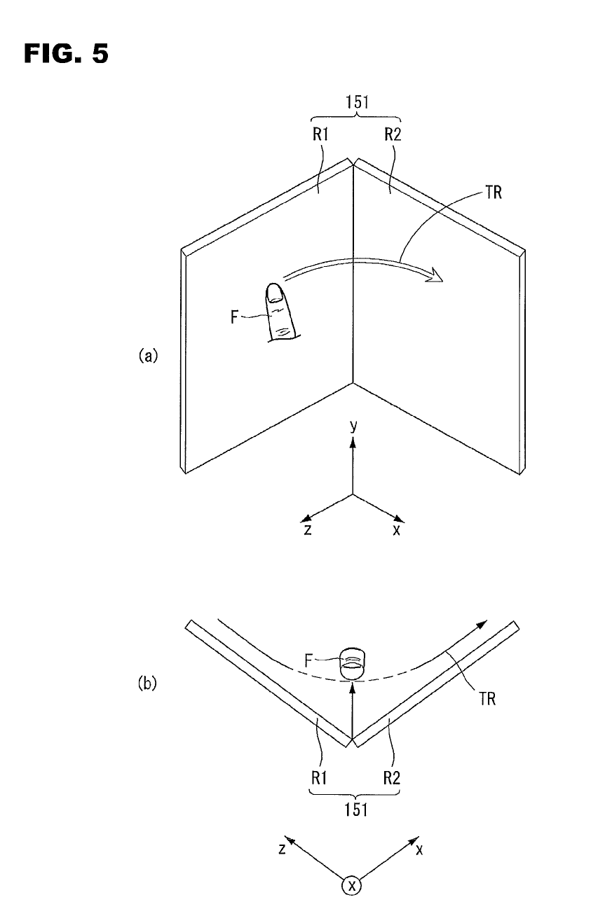

FIGS. 5 to 9 are views illustrating some situations and/or environments to which the embodiments of the present invention.

Referring to FIG. 5, while the display unit 151 is in the bending state, a touch input may be entered by a user's finger F. In the case that a trace TR of the user's finger F is made as shown in (a) and (b) of FIG. 5, when touch input is performed on the display unit 151, the user's finger F may contact the display unit 151 near a border where the display unit 151 is bent or may be spaced apart from the display unit 151 more than a critical distance within which sensing may be done by a proximity sensor. For example, the user's finger F which has been in contact with the first region R1 contacts neither the first region R1 nor the second region R2 near the border between the first and second regions R1 and R2 and is brought in contact with the second region R2.

As a consequence, even though the user performs touch input having such a trace as is shown in FIG. 5 with the intention to input a single touch stroke, the electronic device 100 may recognize the input touch stroke as two touches because in a general touch input, a touch start point and end point are recognized so that one touch stroke is configured.

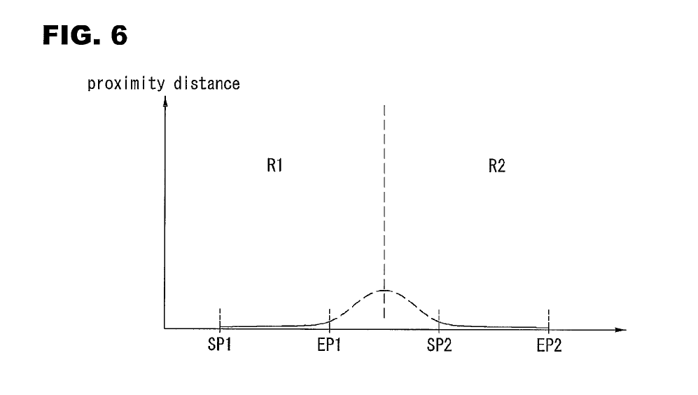

FIG. 6 illustrates the distance (proximate distance) between the finger F and the display unit 151 while the touch trace is made as shown in FIG. 5. Referring to FIG. 6, the user's finger F starts contact with the first region R1 of the display unit 151 at a first start point SP1 and ends the contact with the first region at a first end point EP1. The user's finger F starts contact with the second region R2 at a second start point SP2 and ends the contact with the second region R2 at a second end point EP2. Near a border between the first and second regions R1 and R2, the finger F gradually becomes away from the display unit 151 after passing the first end point EP1 and then gradually becomes closer to the display unit 151 as approaching the second start point SP1, so that the finger F ends up contacting the display unit 151 at the second start point SP2.

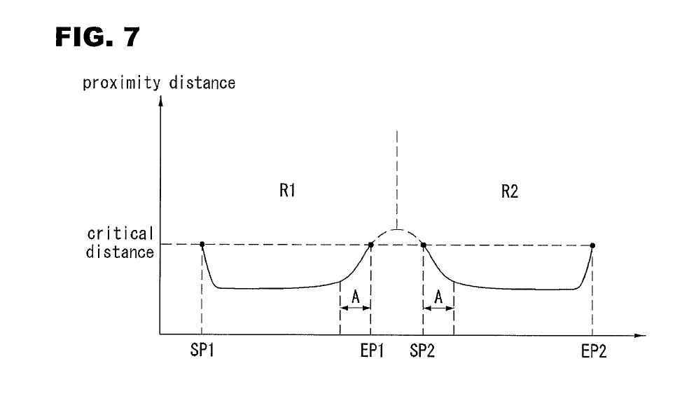

FIG. 7 illustrates the distance (proximate distance) between the finger F and the display unit 151 while the touch trace is made as shown in FIG. 5. The display unit 151 is configured as a touch screen and the electronic device 100 includes a proximity sensor 142 to input a proximate touch through the display unit 151.

Referring to FIG. 7, a curve similar to that shown in FIG. 6 is drawn. However, the curve shown in FIG. 7 is further away from the distance axis, as a whole, compared to the curve shown in FIG. 6. Referring to FIG. 7, the user's finger F starts approaching the first region R1 within a critical distance (which refers to the maximum distance between the display unit 151 and the finger for the proximity sensor to recognize a touch as the proximate touch) from the first start point SP1 by the proximity sensor 142, and becomes away at the first end point EP1 by more than the critical distance. Further, the user's finger F starts approaching again the second region R2 within the critical distance from the second start point SP2 and becomes away at the second end point EP2 by more than the critical distance.

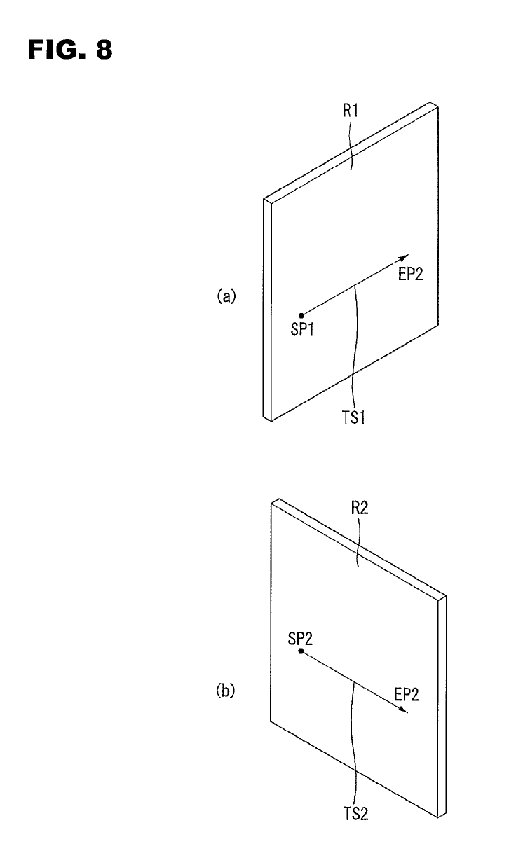

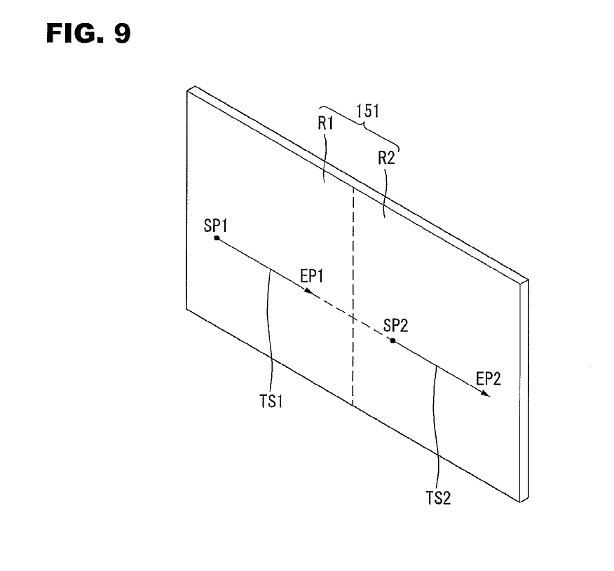

As described in connection with FIGS. 5 to 7, in the case that a touch input having the trace TR shown in FIG. 5 is performed by the user's finger F, the electronic device 100, as shown in FIG. 8, differently recognize the first touch stroke TS1 input on the first region R1 and the second touch stroke TS2 input on the second region R2. If the display unit 151 is in the flat state rather than being in the bending state, the electronic device 100 may recognize that separate touch inputs, such as two touch strokes TS1 and TS2, are made as shown in FIG. 9.

However, if the user performs a touch input having such a trace TR as is shown in FIG. 5, it is more likely to have intended to input a single touch stroke rather than two separate touch strokes TS1 and TS2 as shown in FIGS. 8 and 9. Nonetheless, if the touch input is recognized as two touch strokes under the situation shown in FIG. 5, the user may have to perform a touch input with the finger F contacting the display unit 151 or while the finger F does not depart from the critical distance of the proximity sensor 142 when the user desires to make the touch input while the display unit 151 is in the bending state. This may cause inconvenience.

Hereinafter, various embodiments of the present invention are suggested to address the above problems. For purposes of illustration, methods of controlling an electronic device are implemented by the electronic device 100 described in connection with FIGS. 1 to 4. However, the control methods are not limited as performed by the electronic device 100.

### First Embodiment

A first embodiment of the present invention is now described in greater detail.

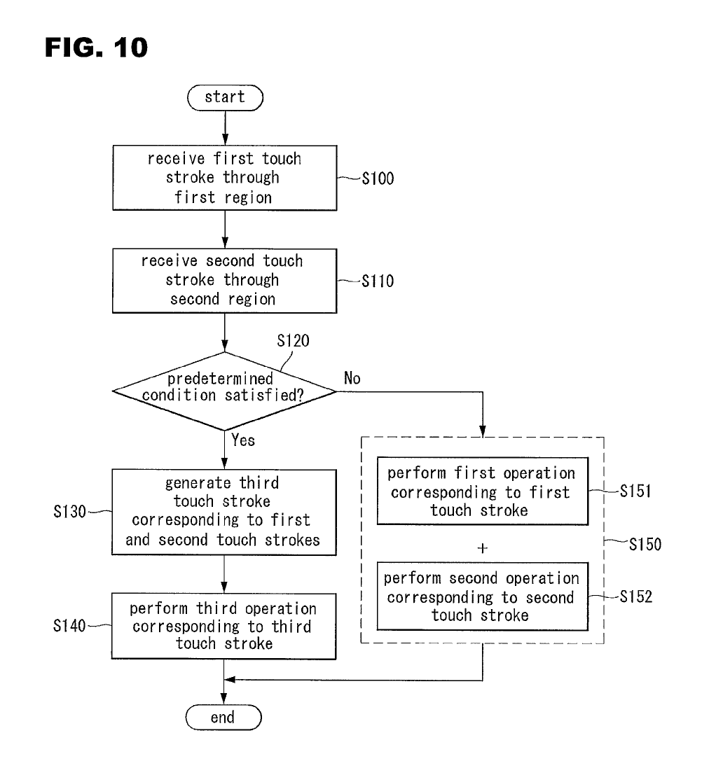

FIG. 10 is a flowchart illustrating a method of controlling an electronic device according to the first embodiment of the present invention. Referring to FIG. 10, the control method includes a step of receiving a first touch stroke through the first region (S100), a step of receiving a second touch stroke through the second region (S110), a step of determining whether the first and second touch strokes meet predetermined conditions (S120), a step of, when the touch strokes meet the conditions, generating a third touch stroke corresponding to the first and second touch strokes (S130), a step of performing a third operation corresponding to the third touch stroke, a step of, when it is determined in step S120 that the strokes do not meet the conditions, performing first and second operations corresponding to the first and second touch strokes, respectively (S151). Each step is now described in detail.

The electronic device 100 may receive a first touch stroke TS1 and a second touch stroke TS2 through the display unit 151. As described above, the display unit 151 may be layered with the touch sensor (for example, the display unit 151 may include a touch screen) or the proximity sensor 142 may be arranged near the display unit 151. The first and second touch strokes TS1 and TS2 may be sensed by the touch screen and/or proximity sensor 142.

When the display unit 151 is bent, the display unit 151 may be divided into the first and second regions R1 and R2. The first touch stroke TS1 and the second touch stroke TS2 may be input through the first and second regions R1 and R2, respectively.

The electronic device 100 may determine whether the second touch stroke TS satisfies the following predetermined conditions with respect to the first touch stroke TS1 (S120). The various predetermined conditions are now described.

First, the electronic device 100 may determine whether the end time of the first touch stroke TS1 and the start time of the second touch stroke TS2 are within a predetermined time range.

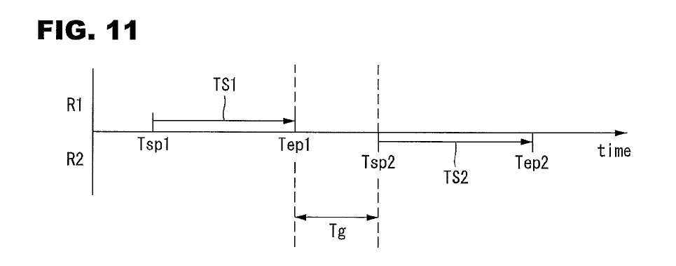

FIG. 11 is a view illustrating a predetermined condition for the relationship in time between the first touch stroke and the second touch stroke according to the first embodiment. Referring to FIG. 11, the first touch stroke TS1 is input through the first region R1, starts at the first start time Tsp1, and ends at the first end time Tep1. The second touch stroke TS2 is input through the second region RS2, starts at the second start end time Tsp2, and ends at the second end time Tep2.

In the situation as shown in FIG. 11, a time gap Tg between the second start time Tsp2 and the first end time Tep1 may be determined. The electronic device 100 may previously set a predetermined range for the time gap Tg. For instance, the electronic device 100 may set the predetermined range within 0.5 seconds. In this case, the electronic device 100 may compare the time gap Tg with the predetermined reference (e.g., 0.5 sec) to determine whether the time gap satisfies the predetermined reference. The time reference, i.e., 0.5 sec, is merely an example, and according to an embodiment, the time reference may be set as other values.

In the case that the second touch stroke TS2 starts within a predetermined time range after the first touch stroke TS1 ends, the electronic device 100 may determine that the second touch stroke TS2 is made as an extension of the first touch stroke TS1. As described in connection with FIG. 5, it may be determined that the first and second touch strokes TS1 and TS2 have been input by a user making a single touch input with the trace TR shown in FIG. 5.

Second, the electronic device 100 may determine whether a difference between a trace direction of the first touch stroke TS1 and a trace direction of the second touch stroke TS2 is within a predetermined range.

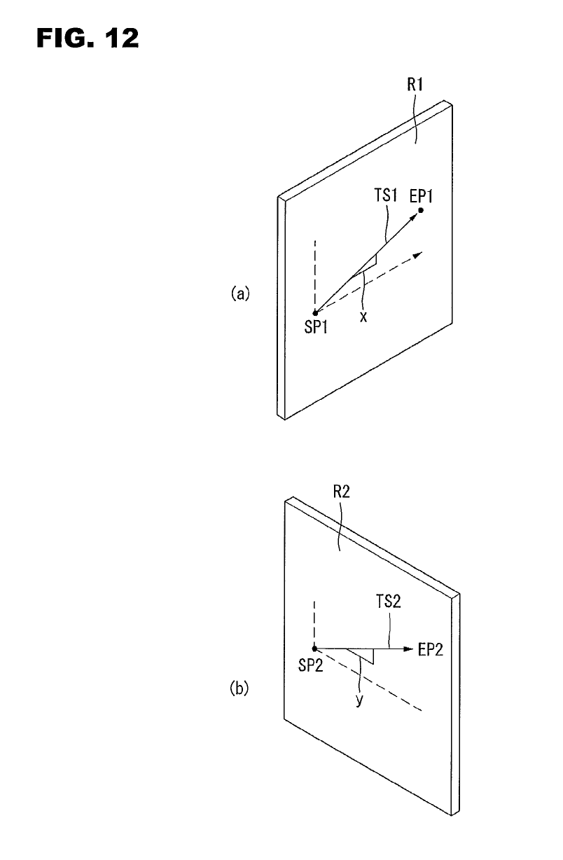

FIG. 12 is a view illustrating a predetermined condition for the relationship in trace direction between the first and second touch strokes according to the first embodiment.

Referring to FIG. 12, when the first touch stroke TS1 is input through the first region R1, the electronic device 100 may produce a slope x of the first touch stroke TS1, for example, based on the coordinates of the start point SP1 and end point EP1 of the first touch stroke TS1 input through a touch sensor.

To obtain the slope of the touch stroke TS1, it is not necessary to have to use the coordinates of the start and end points SP1 and EP1 of the first touch stroke TS1. For example, the slope x may be also obtained by calculating a slope between any two points selected on the first touch stroke TS1. In the case that the slope of the first touch stroke TS1 varies with the touch input rather than having a constant value, the electronic device 100 may use one representative slope value. For example, the electronic device 100 may determine an average slope value of the varying slopes of the first touch stroke TS1 as the slope x of the first touch stroke TS1.

The electronic device 100 may determine a slope y of the second touch stroke TS2 by a method identical or similar to the method for obtaining the slope x.

The electronic device 100 may compare the slope x of the first touch stroke TS1 with the slope y of the second touch stroke TS2 and may determine whether a difference between the slope x and the slope y is within a predetermined slope gap.

The predetermined slope gap may be a constant value or may vary depending on the slope x. For example, as the slope x increases, the slope gap may increase as well, or on the contrary, as the slope x decreases, the slope gap may also decrease.

Accordingly, the electronic device 100 may determine whether the trace direction of the second touch stroke TS2 is similar to the trace direction of the first touch stroke TS1 by a predetermined ‘similarity’ range. For example, when the slope gap between the touch strokes TS1 and TS2 is within a predetermined time slope gap, the electronic device 100 may determine that the second touch stroke TS2 is made as an extension of the first touch stroke TS1. As described in connection with FIG. 5, it may be determined that the first and second touch strokes TS1 and TS2 have been input by a single touch trace TR shown in FIG. 5.

Third, the electronic device 100 may determine whether the position of the start point SP2 of the second touch stroke TS2 is within a predetermined range determined based on the position of the end point EP1 of the first touch stroke TS1.

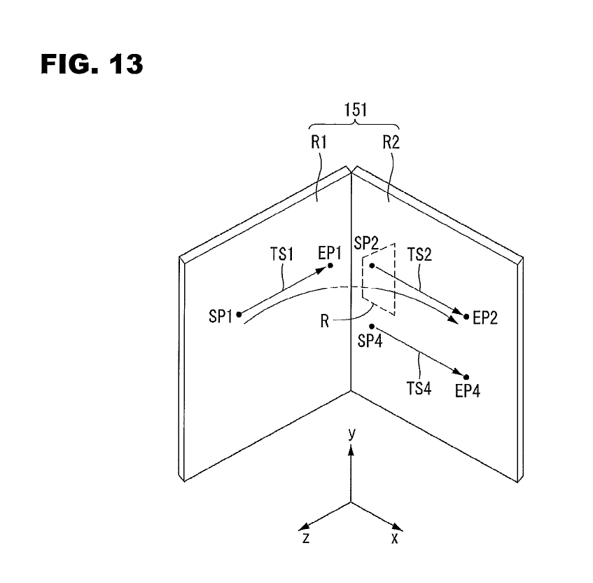

FIG. 13 is a view illustrating a predetermined condition for the relationship in position between the first and second touch strokes according to the first embodiment.

Referring to FIG. 13, when the first touch stroke TS1 input through the first region R1 ends, the electronic device 100 may identify the position of the end point EP1 of the first touch stroke TS1. For example, the electronic device 100 may obtain a coordinate of the end point EP1 through a touch sensor and/or the proximity sensor 142. The electronic device 100 may set a predetermined range R in the second region R2 according to a predetermined algorithm, the range R being determined based on the end point EP1 of the first touch stroke TS1.

For example, in the case that the end point EP1 of the first touch stroke TS1 is positioned as shown in FIG. 13, when the predetermined range R set in the second region R2 is as shown in FIG. 13 according to the algorithm preset in the electronic device 100, the second touch stroke TS2, which starts in the predetermined range R, may be determined to satisfy the predetermined condition. However, a fourth touch stroke TS4 starting at a position departing from the predetermined range R may be determined not to satisfy the predetermined condition.

The predetermined range R may have various shapes. For instance, the range R is shaped as a trapezoid as shown in FIG. 13. However, according to an embodiment, the range R may be also shaped as a circle, ellipse, triangle, rectangle, or square. In the case of a shape having edges, the edges are connected to each other either by a straight line or by a curved line. For example, according to an embodiment, the range R may have a fan shape.

When the start point SP2 of the second touch stroke TS2 is positioned within the range R, the electronic device 100 may determine that the second touch stroke TS2 is made as an extension of the first touch stroke TS1. As described in connection with FIG. 5, it may be determined that the first and second touch strokes TS1 and TS2 are input by a user making a single touch having the trace TR shown in FIG. 5.

Fourth, the electronic device 100 may determine whether a difference in speed between the first and second touch strokes TS1 and TS2 is within a predetermined range.

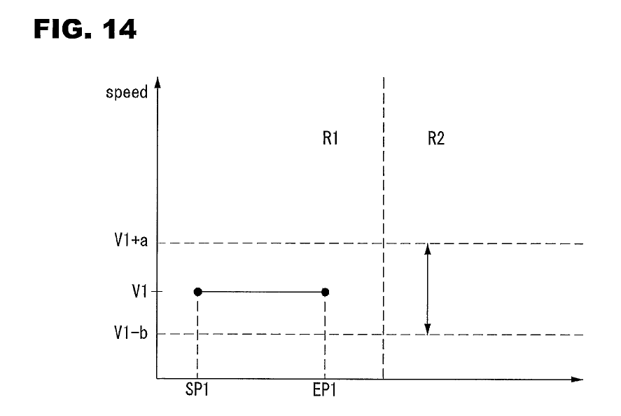

FIG. 14 is a view illustrating a predetermined condition for the relationship in speed between the first and second touch strokes according to the first embodiment.

The electronic device 100 may calculate the coordinates of the start and end points SP1 and EP1 of the first touch stroke TS1 and start and end times of the first touch stroke TS1 based on an output from the touch sensor and/or proximity sensor 142. Accordingly, the electronic device 100 may calculate the speed of the first touch stroke TS1 based on a time difference between the start and end times of the first touch stroke TS1 and the length of the first touch stroke TS1. However, the embodiments of the present invention are not limited thereto. According to an embodiment, the speed of the first touch stroke TS1 may also be calculated based on a length determined by any two points on the first touch stroke TS1 and the time difference thereof.

In the case that the speed of the first touch stroke TS1 continues to vary while the first touch stroke TS1 is input, the electronic device 100 may determine a representative value as the speed of the first touch stroke TS1. By the same or similar method, the electronic device 100 may calculate the speed of the second touch stroke TS2. If there is a large gap between the start time and the end time of the second touch stroke TS2, the speed of the second touch stroke TS2 may not be calculated until the stroke TS2 ends. To address such situation, according to an embodiment, the electronic device 100 may determine as the speed of the second touch stroke TS2 an instant speed of the second touch stroke TS2 when the stroke TS2 is positioned near the start point SP2.

Referring to FIG. 14, the speed of the first touch stroke TS1 input through the first region R1 remains a constant speed V1. The electronic device 100 may calculate a predetermined speed range determined by the speed V1 of the first touch stroke TS1 and may determine whether the speed of the second touch stroke TS2 is within the predetermined speed range. For example, if the speed of the second touch stroke TS2 (for example, the instant speed when the second touch stroke is positioned near the start point) is V2, the electronic device 100 may determine whether the following equation is met: V1−b≦V2≦V1+a. Here, ‘a’ may be the same as or different from ‘b’. ‘a’ and ‘b’ each may have a constant value irrespective of V1 or may vary depending on V1.

When the speed of the second touch stroke TS2 is within the predetermined time speed range determined by the first touch stroke TS1, the electronic device 100 may determine that the speed of the second touch stroke TS2 is substantially the same as the speed of the first touch stroke TS1 and that the second touch stroke TS2 is made as an extension of the first touch stroke TS1. As described in connection with FIG. 5, it may be determined that the first and second touch strokes TS1 and TS2 have been input by a user making a single touch input having the trace TR shown in FIG. 5.

Finally, when the touch input by a user is a proximity touch sensed by the proximity sensor 142, the electronic device 100 may determine whether the proximity distance of the user's finger F and the display unit 151 varies within a predetermined range near the end time of the first touch stroke TS1 and the start point of the second touch stroke TS2.

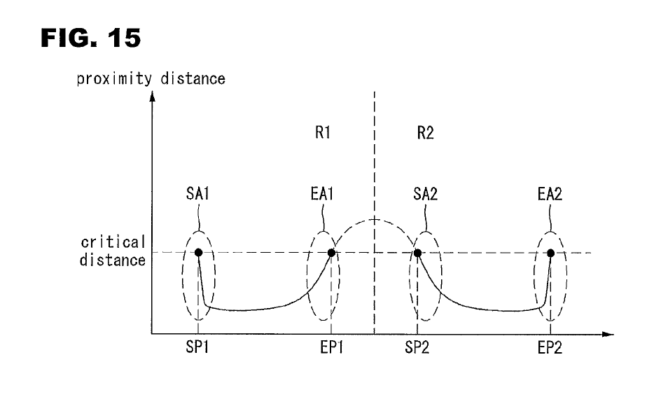

FIG. 15 is a view illustrating a predetermined condition for the proximity distance of the finger and the display unit upon input of the first and second touch strokes according to the first embodiment.

In general, when a user makes a proximity touch having a trace on a flat touch screen using his finger F (hereinafter, often referred to as a “touching body”), the slope of the distance between the user's finger F and the display unit 151 with respect to the touch travelling distance on the display unit 151 near the start point of the touch input is nearly 90 degrees. For example, as shown in FIG. 15, the slope of the curved line is substantially 90 degrees near the start point SA1 of the first touch stroke TS1 and the end point EA2 of the second touch stroke TS2.

If the display unit 151 is in the bending state as described in connection with FIGS. 5 to 9, when two touch strokes TS1 and TS2 are input by the user's touch trace TR, the slope of the distance between the finger F and the display unit 151 with respect to the touch travelling distance on the display unit 151 may be gentler near the end point EP1 of the first touch stroke TS1 and near the start point SP2 of the second touch stroke TS2.

Accordingly, the electronic device 100 which has a predetermined slope range in advance, may determine whether the slope of the proximity distance relative of the touch travelling distance near the end point EP1 of the first touch stroke TS1 and near the start point SP2 of the second touch stroke TS2 belongs to the predetermined slope range.

If it is determined that the slope of the proximity distance belongs to the predetermined slope range, the electronic device 100 may determine that the second touch stroke TS2 has been made as an extension of the first touch stroke TS1. As described in connection with FIG. 5, it may be determined that the first and second touch strokes TS1 and TS2 have been input by a user making a single touch input having the trace TR shown in FIG. 5.

Various methods for determining whether the relationship between the touch strokes TS1 and TS2 have been described so far. However, according to an embodiment, such relationship may also be determined by a combination of the various methods rather than by a single one of the methods. For example, the electronic device 100 may determine that the relationship between the touch strokes TS1 and TS2 satisfies the predetermined condition when the end time of the first touch stroke TS1 and the start time of the second touch stroke TS2 are within a predetermined range while the position of the start point SP2 of the second touch stroke TS2 is within a predetermined range determined by the end point of the second touch stroke TS1. Alternatively, various combinations of the conditions may be made.

As described above, the electronic device 100 may determine whether the relationship between the touch strokes TS1 and TS2 meets a predetermined condition. If it is determined that the relationship meets the predetermined condition, the electronic device 100 may generate a virtual third touch stroke TS3 corresponding to the touch strokes TS1 and TS2 (S130).

The third touch stroke TS3 may be generated by various methods.

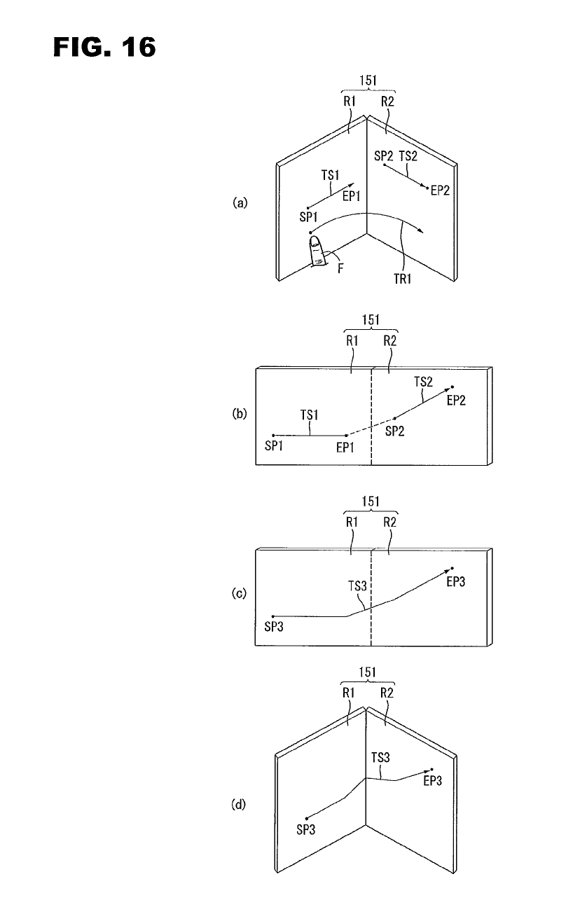

FIGS. 16 to 18 illustrate various methods of generating the virtual third touch stroke according to the first embodiment. Hereinafter, for purposes of description, the first and second touch strokes TS1 and TS2 as shown in FIGS. 16 to 18 satisfy the predetermined conditions.

A first method is now described with reference to FIG. 16.

Referring to (a) of FIG. 16, the user performs a touch input having a first trace TR1 using his finger F, so that a first touch stroke TS1 having the first start point SP1 and the first end point EP1 is input through the first region R1 and a second touch stroke TS2 having the second start point SP2 and the second end point EP2 is input through the second region R2. Referring to (b) of FIG. 16, it is assumed, for ease of description, that the touch strokes TS1 and TS2, which have been input when the display unit 151 was in the bending state, are input when the display unit 151 is in the flat state.

Under this situation, the electronic device 100 may generate the third touch stroke TS3 by establishing the start point SP3 as the start point SP1 of the first touch stroke TS1, the end point EP3 as the end point EP2 of the second touch stroke TS2, and inflection points as the end point EP1 of the first touch stroke TS1 and the start point SP2 of the second touch stroke TS2. For example, despite the fact that no touch connecting the end point EP1 of the first touch stroke TS1 with the start point SP2 of the second touch stroke TS2 is input, it is assumed that there is a touch connecting the end point EP1 of the first touch stroke TS1 with the start point SP2 of the second touch stroke TS2, thereby generating the third touch stroke TS3. (c) and (d) of FIG. 16 illustrate a third touch stroke generated by the above-described method. (c) of FIG. 16 illustrates a trace of the third touch stroke TS3 when the display unit 151 is assumed to be in the flat state, and (d) of FIG. 16 illustrates what trace may be formed for the third touch stroke TS3 when the display unit 151 is actually in the flat state as shown in (a) of FIG. 16.

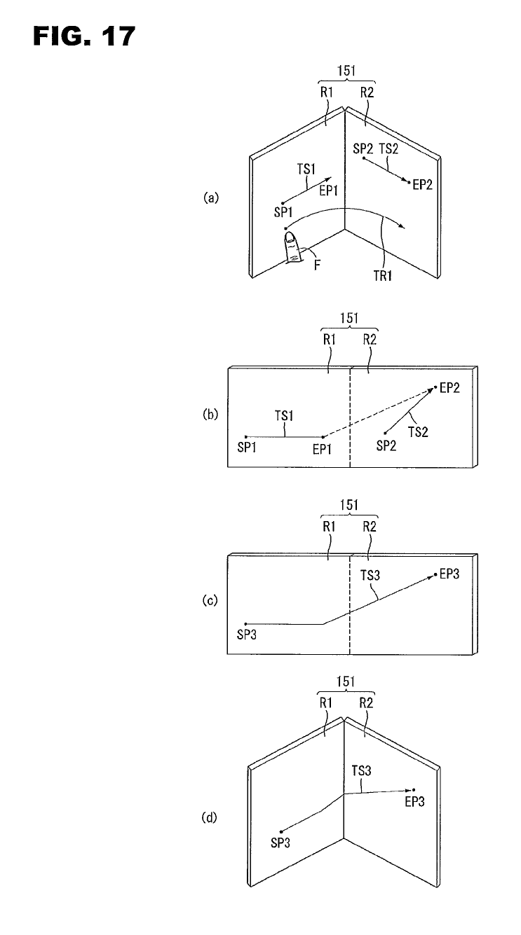

A second method is now described with reference to FIG. 17. (a) of FIG. 17 shows the same situation as that shown in (a) of FIG. 16. Referring to (b) of FIG. 17, it is assumed, for ease of description, that the touch strokes TS1 and TS2, which have been input when the display unit 151 was in the bending state, are input when the display unit 151 is in the flat state.

Under this situation, the electronic device 100 may generate the third touch stroke TS3 by establishing the start point SP3 as the start point SP1 of the first touch stroke TS1, the end point EP3 as the end point EP2 of the second touch stroke TS2, and an inflection point as the end point EP1 of the first touch stroke TS1. For example, despite the fact that no touch connecting the end point EP1 of the first touch stroke TS1 with the end point EP2 of the second touch stroke TS2 is input, it is assumed that there is a touch connecting the end point EP1 of the first touch stroke TS1 with the end point EP2 of the second touch stroke TS2, thereby generating the third touch stroke TS3. (c) and (d) of FIG. 17 illustrate a third touch stroke generated by the above-described method. (c) of FIG. 17 illustrates a trace of the third touch stroke TS3 when the display unit 151 is assumed to be in the flat state, and (d) of FIG. 17 illustrates what trace may be formed for the third touch stroke TS3 when the display unit 151 is actually in the flat state as shown in (a) of FIG. 17.

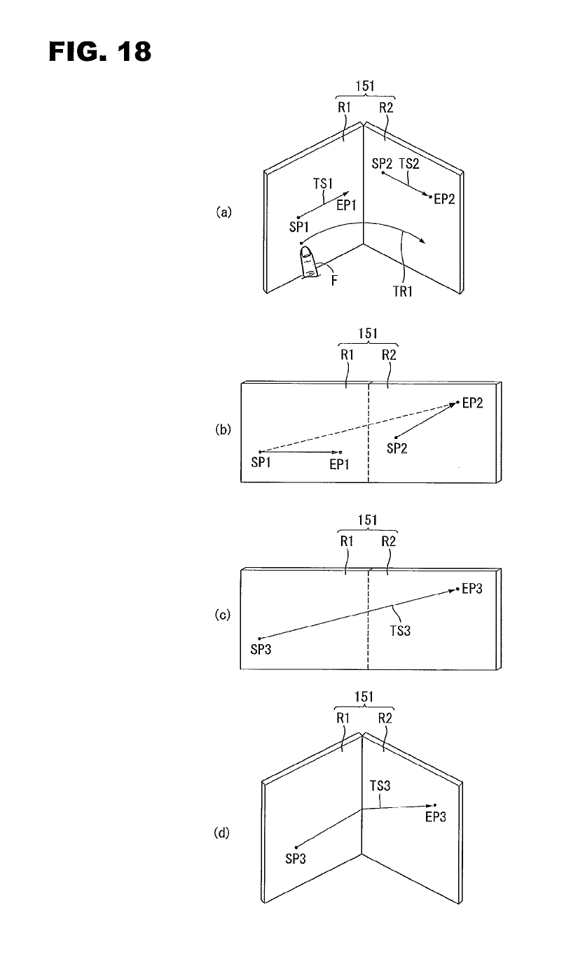

A third method is now described with reference to FIG. 18. (a) of FIG. 18 shows the same situation as that shown in (a) of FIG. 16. Referring to (b) of FIG. 18, it is assumed, for ease of description, that the touch strokes TS1 and TS2, which have been input when the display unit 151 was in the bending state, are input when the display unit 151 is in the flat state.

Under this situation, the electronic device 100 may generate the third touch stroke TS3 by establishing the start point SP3 as the start point SP1 of the first touch stroke TS1 and the end point EP3 as the end point EP2 of the second touch stroke TS2. For example, despite the fact that no touch connecting the start point SP1 of the first touch stroke TS1 with the end point EP2 of the second touch stroke TS2 is input, it is assumed that there is a touch connecting the start point SP1 of the first touch stroke TS1 with the end point EP2 of the second touch stroke TS2, thereby generating the third touch stroke TS3. (c) and (d) of FIG. 18 illustrate a third touch stroke generated by the above-described method. (c) of FIG. 18 illustrates a trace of the third touch stroke TS3 when the display unit 151 is assumed to be in the flat state, and (d) of FIG. 18 illustrates what trace may be formed for the third touch stroke TS3 when the display unit 151 is actually in the flat state as shown in (a) of FIG. 17.

As described above, when the relationship between the touch strokes TS1 and TS2 satisfies the predetermined reference, the electronic device 100 may generate the virtual third touch stroke TS3 corresponding to the touch strokes TS1 and TS2 by various methods.

Turning back to FIG. 10, after generating the third touch stroke TS3, the electronic device 100 may perform an operation corresponding to the third touch stroke TS3. There may be various operations corresponding to the third touch stroke TS3 according to the state of the electronic device 100. For example, the operation may vary with the type of the application in execution by the display unit 151 or may vary depending on the screen image displayed on the display unit 151.

If it is determined in step S120 that the relationship between the touch strokes TS1 and TS2 does not meet the predetermined condition, the electronic device 100 may perform an operation corresponding to the first touch stroke TS1 and an operation corresponding to the second touch stroke TS2 (S150).

As such, in the case that the display unit 151 is in the bending state, when a user attempts to input a touch stroke starting at the first region R1 and ending at the second region R2, the user need not perform a touch input with his finger in contact with the display unit 151 or with the finger remaining in the critical distance from the display unit 151. The user may make a touch input on the display unit 151 which remains in the bent state using his finger to input a desired command to the electronic device 100, thus providing increased convenience.

### Second Embodiment

A second embodiment of the present invention is now described in greater detail.

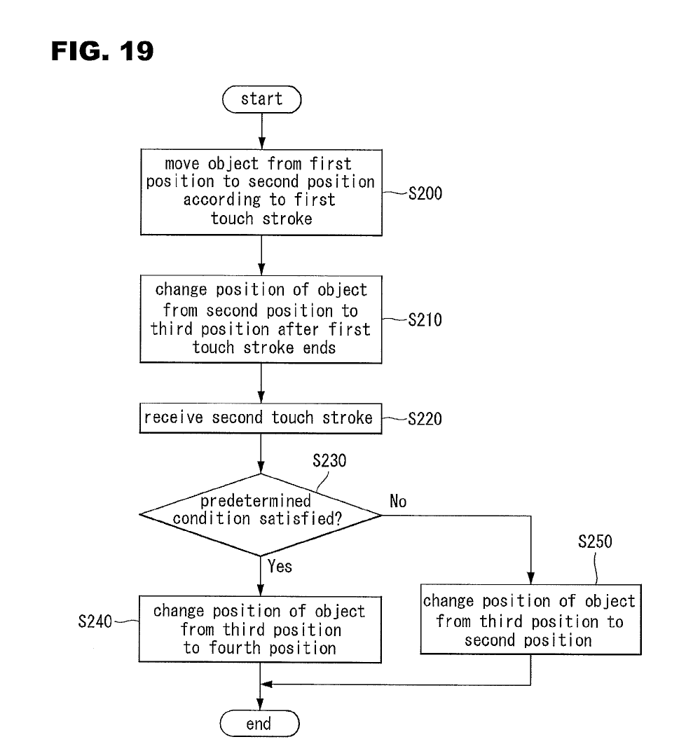

FIG. 19 is a flowchart illustrating a method of controlling an electronic device according to the second embodiment of the present invention. Referring to FIG. 19, the control method includes a step of moving an object from a first position to a second position according to a first touch stroke input through the first region (S200), a step of changing the position of the object from the second position to a third position after the first touch stroke ends (S210), a step of receiving a second touch stroke through the second region (S220), and a step of determining whether a relationship between the first and second touch strokes satisfies a predetermined condition (S230). If it is determined that the relationship meets the predetermined condition, the control method may further include a step of changing the position of the object from the third position to a fourth position (S240), and if it is determined that the relationship does not meet the condition, the control method may further include a step of changing the position of the object from the third position back to the second position (S250). Each step is now described in detail. According to an embodiment, step S230 may be the same or substantially the same as step S120 of the control method according to the first embodiment.

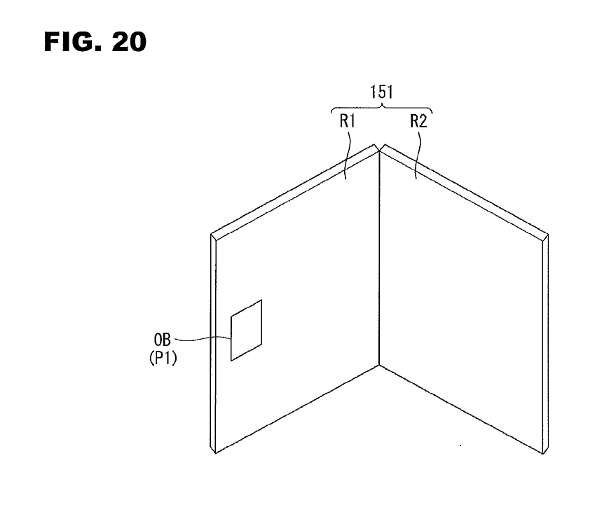

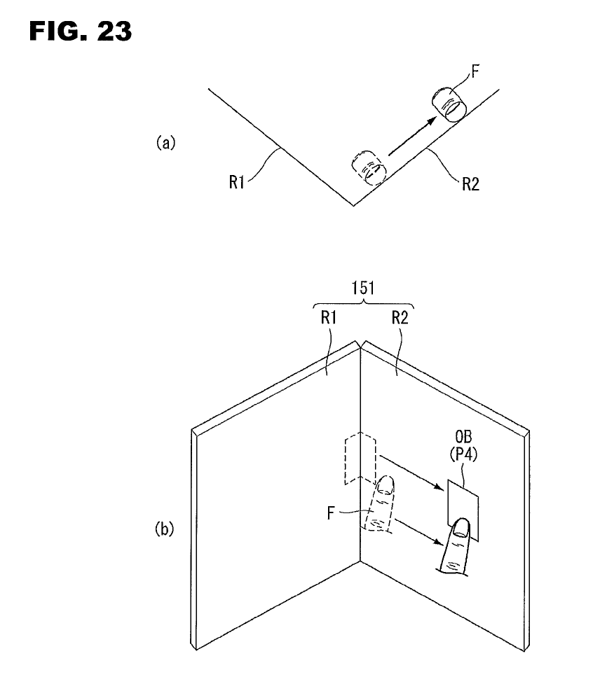

FIGS. 20 to 24 illustrate a method of controlling an electronic device according to the second embodiment. The control method is now described in greater detail with reference to FIGS. 20 to 24.

As shown in FIG. 20, the electronic device 100 displays an object OB on the first region R1 of the display unit 151.

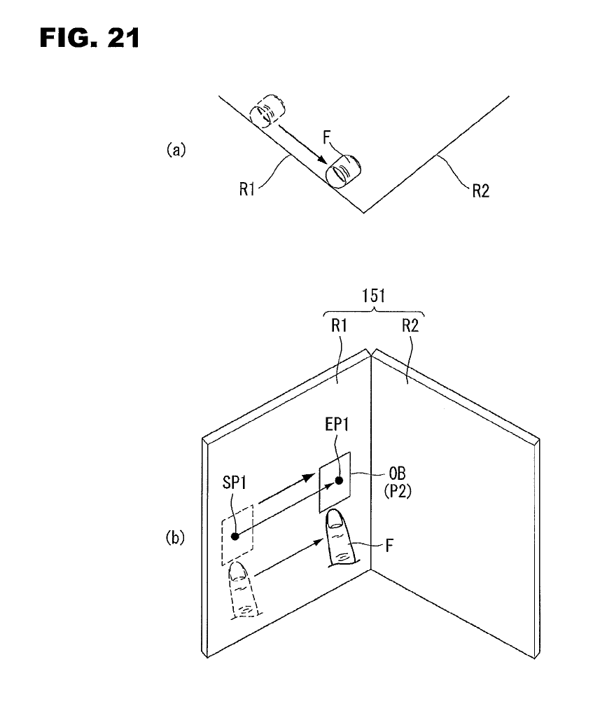

As shown in (a) of FIG. 21, the electronic device 100 may receive a first touch stroke TS1 through the first region R1. As shown in (b) of FIG. 21, the electronic device 100 may change the object OB from the first position P1 to the second position P2 depending on the first touch stroke TS1. Specifically, in the case that the start point SP1 of the first touch stroke TS1 corresponds to the first position P1 where the object OB is displayed, the electronic device 100 may change the position of the object OB according to a trace of the first touch stroke TS1. The second position P2 may correspond to the end point EP1 of the first touch stroke TS1.

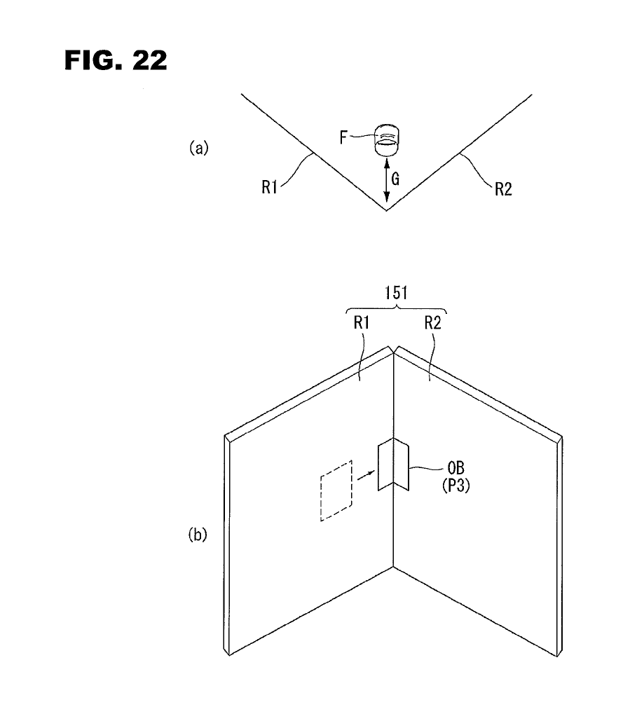

Subsequently, after the first touch stroke TS1 ends, the electronic device 100 may change the object OB from the second position P2 to the third position P3 (S210). As shown in FIG. 5, when the user makes a touch input having a particular trace TR, the user's finger F, which has been in contract with the display unit 151, may be contactless or away from the display unit 151 further than the critical distance of the proximity sensor 142 (refer to (a) of FIG. 22). As such, after the input of the first touch stroke TS1 ends, the electronic device 100 may move the object OB from the second position P2 to the third position P3 as shown in (b) of FIG. 22.

When the object OB changes from the second position P2 to the third position P3, a travelling speed of the object OB may correspond to a travelling speed of the object OB when the object OB is moved from the first position P1 to the second position P2 depending on the first touch stroke TS1. The object OB may travel at constant or varying speed from the second position P2 to the third position P3. For example, the speed of the object OB may decrease as the object OB gets close to the third position P3.

When the object OB changes its position from the second position P2 to the third position P3, the travelling direction of the object OB may correspond to a travelling direction of the object OB when the object OB is moved from the first position P1 to the second position P2 according to the first touch stroke TS1.

The third position P3 may be determined by various methods.

For example, in the case that a predetermined time conditions is set as described in connection with FIG. 11 in performing step S230, the third position P3 may be determined in consideration of the travelling speed and/or direction determined above and the maximum value of the predetermined time condition. For example, if the maximum value of the time conditions is 0.5 seconds, the electronic device 100 may move the object OB at the determined travelling speed for 0.5 seconds along the direction corresponding to the first touch stroke TS1, thereby determining the third position P3.

As another example, the electronic device 100 may continue to move the object OB based on the travelling speed and/or direction determined above until step S230 is complete, thereby determining the third position P3.

As still another example, the electronic device 100 may continue to move the object OB based on the travelling speed and/or direction determined above until the second touch stroke TS2 is input in step S220, thereby determining the third position P3.

As yet still another example, the third position P3 may be preset by the electronic device 100 regardless of step S220 and/or step S230.

Subsequently, the electronic device 100 may receive the second touch stroke TS2 through the second region R2 (S220) and may determine whether a relationship between the touch strokes satisfies a predetermined condition (S230). The determining method in step S230 has been described in connection with FIGS. 11 to 15.

If it is determined in step S230 that the relationship between the touch strokes TS1 and TS2 satisfies the predetermined condition, the electronic device 100 may change the object OB from the third position P4 to the fourth position P4 (S240). For example, if it is determined that the second touch stroke TS received through the second region R2 conforms to the predetermined condition with respect to the first touch stroke TS1, the electronic device 100 may move the object OB from the third position P3 to the fourth position P4. The fourth position P4 may correspond to the end point EP2 of the second touch stroke TS2.

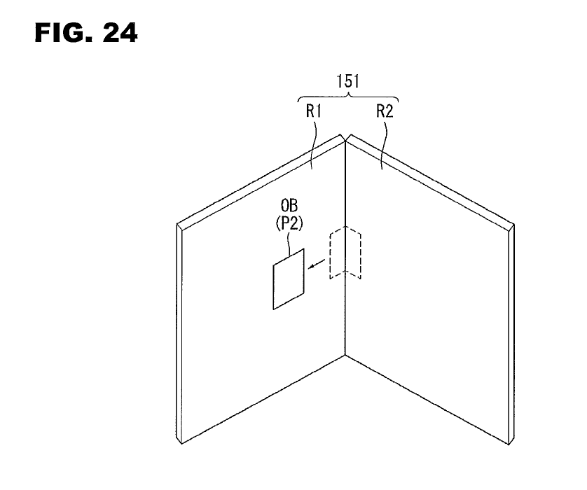

If it is determined in step S230 that the relationship between the touch strokes TS1 and TS2 does not meet the predetermined condition, the electronic device 100 may change the object OB from the third position P3 back to the second position P2 as shown in FIG. 24 (S250).

In sum, according to the second embodiment, the electronic device 100 may change the position of the object OB to the third position P3, and according to whether the second touch stroke TS2 is input through the second region R2 and/or whether the relationship between the touch strokes TS1 and TS2 meets the predetermined condition, may then change the position of the object OB to the fourth position P4 or back to the second position P2.

By doing so, even when the user does not continue to perform the touch input on the display unit 151 at a bent portion of the display unit 151 when the display unit 151 is in the bending state, the object which is being moved by the first touch stroke input through the first region may be continuously displayed even after the first touch strokes ends, and according to whether the second touch stroke is input through the second region and/or whether the relationship between the first and second touch strokes satisfies the predetermined condition, the position of the object may be selectively changed to a position corresponding to the second touch stroke or corresponding to the end point of the first touch stroke, thereby providing the user with more smooth visual feedback.

### Third Embodiment

A third embodiment of the present invention is now described in greater detail.

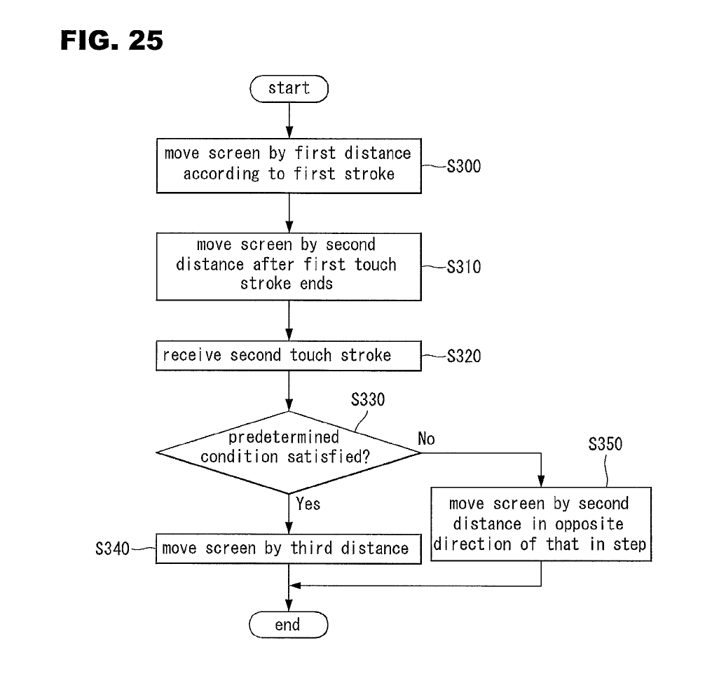

FIG. 25 is a flowchart illustrating a method of controlling an electronic device according to the third embodiment. Referring to FIG. 25, the control method includes a step of moving a screen image by a first distance according to a first touch stroke input through the first region (S300), a step of moving the screen image by a second distance after the first touch stroke ends (S310), a step of receiving a second touch stroke through the second region (S320), and a step of determining whether a relationship between the first and second touch strokes satisfies a predetermined condition (S330). If the relationship between the first and second touch strokes satisfies the predetermined condition, the control method may further include a step of further moving the screen image by a third distance (S340), and if the relationship does not satisfy the condition, the control method may further include a step of moving the screen image in the opposite direction of the moving direction of the screen image in step S310 by the second distance (S350). Hereinafter, each step is described specifically. Step S330 may be the same or substantially the same as step S120.

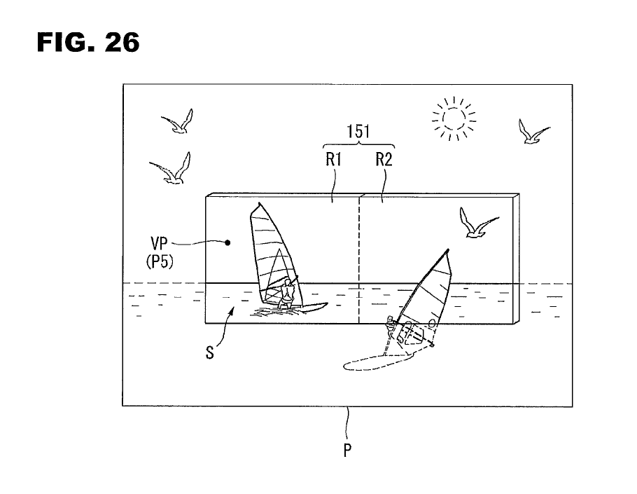

FIGS. 26 to 31 illustrate a method of controlling an electronic device according to the third embodiment. The control method is described in greater detail with reference to FIGS. 26 to 31.

In general, when an image P is displayed on the display unit 151 of the electronic device 100, only a portion of the image P may be sometimes displayed on the display unit 151 as shown in FIG. 26. For example, only a portion of an image corresponding to a webpage or only a portion of an image, such as a picture, may be displayed on the display unit 151. Hereinafter, the portion of the image P, which is displayed on the display unit 151, is referred to as a “screen S”. And, this situation may also be represented as the phrase “portion of the image P is displayed through the screen S.”

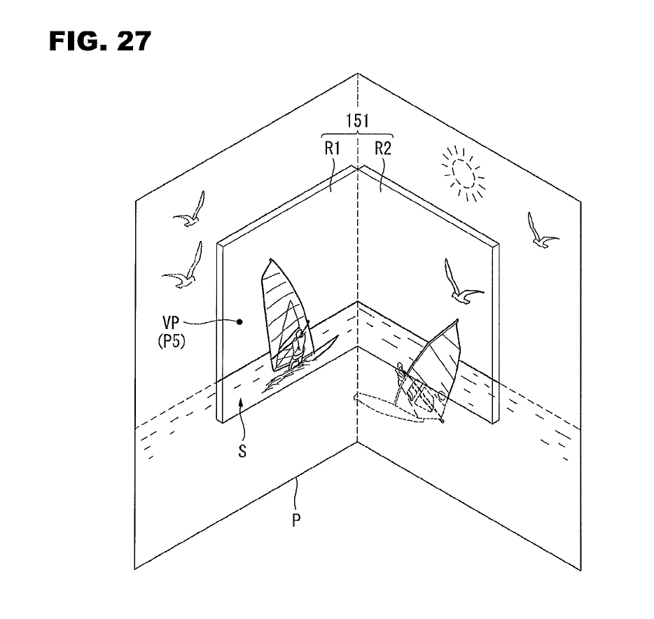

As shown in FIG. 27, the electronic device 100 may display the portion (e.g., portion S) of the image P on the display unit 151 even when the display unit 151 is in the bending state.

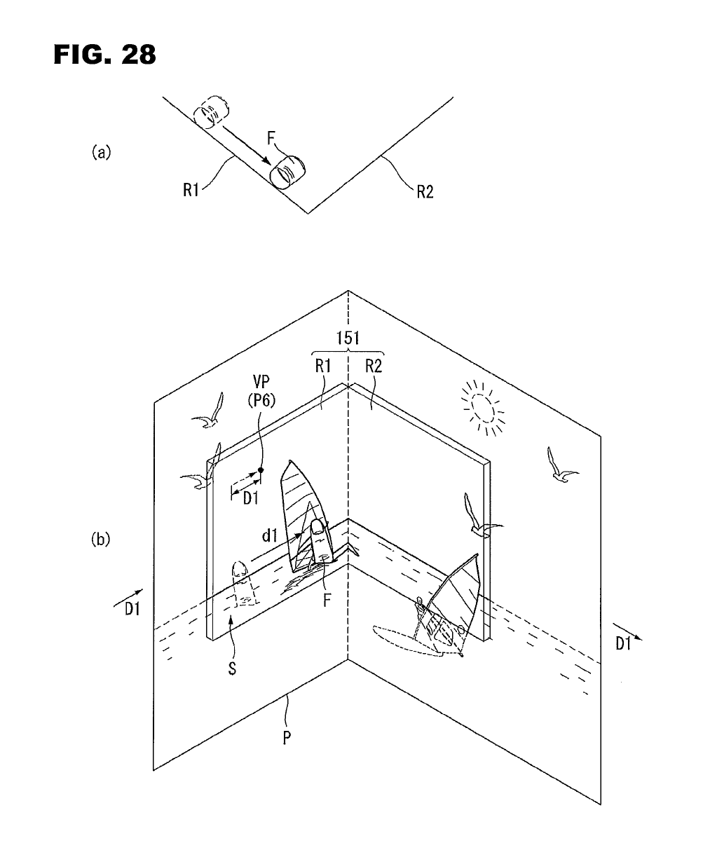

The electronic device 100 may receive the first touch stroke TS1 through the first region R1 as shown in (a) of FIG. 28. As shown in (b) of FIG. 28, the electronic device 100 may move the screen S by a first distance D1 in response to the first touch stroke TS1 (S300). If a virtual point VP is selected on the screen S, the virtual point VP may be moved from a fifth position (P5 shown in FIGS. 26 and 27) to a sixth position P6. The first distance D1 may correspond to a travelling distance d1 of the first touch stroke TS1. The travelling direction of the screen S may correspond to the direction of the trace (i.e., the travelling direction) of the first touch stroke TS1.

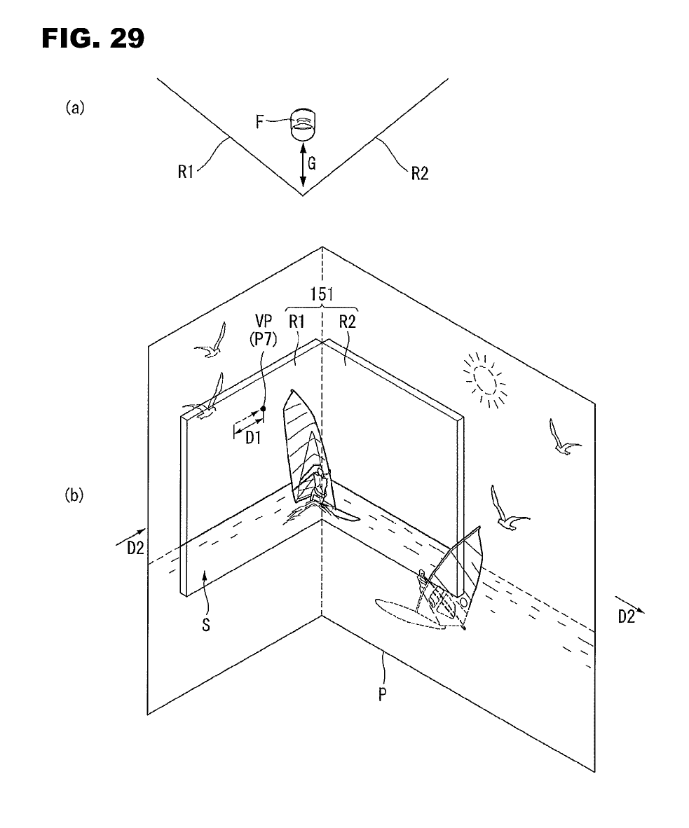

Subsequently, after the first touch stroke TS1 ends, the electronic device 100 may move the screen S by a second distance D2 (S310). In the case that as shown in FIG. 5 the user makes a touch input having a particular trace TR, the user's finger F, which has been in contact with the display unit 151, may be not in contact with the display unit 151 any longer or may be away from the display unit 151 further than the critical distance of the proximity sensor 142 (refer to (a) of FIG. 29). As such, after the input of the first touch stroke TS1 ends, the electronic device 100 may continue to move the screen S by the second distance D2 as shown in (b) of FIG. 29. For example, the virtual point VP may be moved from the sixth position P6 to a seventh position P7.

When the screen S is moved by the second distance D2, the travelling speed of the screen S may correspond to the travelling speed of the screen S when the screen S is moved by the first distance D1 in response to the first touch stroke TS1. The screen S may travel at constant or varying speed. For example, the travelling speed of the screen S may gradually decrease.

When the screen S is moved by the second distance D2, the travelling direction of the screen S may correspond to the travelling direction of the screen S2 when the screen S is moved by the first distance D1 in response to the first touch stroke TS1.

The second distance D2 may be determined by various methods.

For example, as described in connection with FIG. 11, in the case that a predetermined time condition is set upon performing step S330, the second distance D2 may be determined in consideration of the travelling speed and/or direction of the screen S determined above and the maximum value of the predetermined time condition. If the maximum value of the predetermined time condition is 0.5 seconds, the electronic device 100 may travel the screen S at the determined travelling speed along a direction corresponding to the first touch stroke TS1 for 0.5 seconds, thereby determining the second distance D2.

As another example, the electronic device 100 may continue to move the screen S based on the travelling speed and/or direction determined above until the determination in step S330 is complete, thereby determining the second distance D2.

As still another example, the electronic device 100 may continue to move the screen S based on the travelling speed and/or direction determined above until the second touch stroke TS2 is input in step S320, thereby determining the second distance D2.

As yet still another example, the second distance D2 may be preset by the electronic device 100 regardless of step S320 and/or step S330.

Subsequently, the electronic device 100 may receive the second touch stroke TS2 through the second region R2 (S320) and may determine whether a relationship between the first and second touch strokes satisfies a predetermined condition (S330). The determination method in step S330 has been described above in connection with FIGS. 11 to 15.

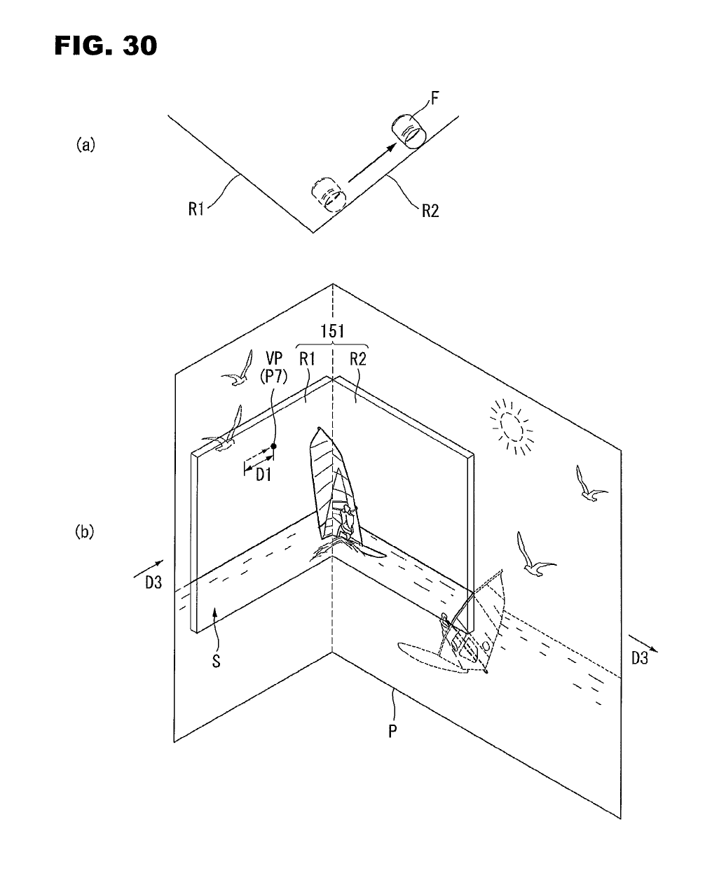

If it is determined in step S330 that the relationship between the touch strokes TS1 and TS2 satisfies the predetermined condition, the electronic device 100 may move the screen S by a third distance D3 (S340). For example, in the case that the second touch stroke TS2 received through the second region as shown in (a) of FIG. 30 conforms to the predetermined condition with respect to the first touch stroke TS1, the electronic device 100 may move the screen S by the third distance D3. For example, the virtual point VP may be moved from the seventh position P7 to an eighth position P8 spaced apart from the seventh position P7 by the third distance D3. The third distance D3 may correspond to the travelling distance d2 of the second touch stroke TS2.

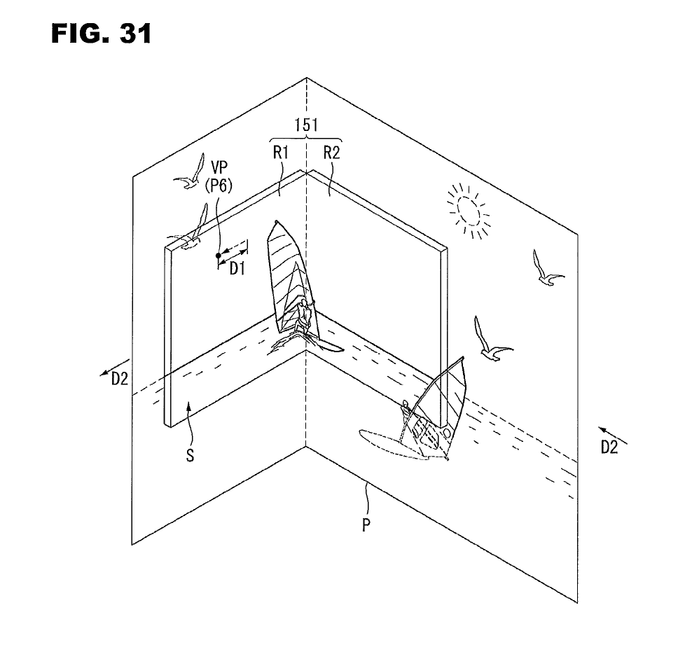

If it is determined in step S330 that the relationship between the touch strokes TS1 and TS2 does not satisfy the predetermined condition, the electronic device 100, as shown in FIG. 31, may move the screen by the second distance D2 in the opposite direction of the travelling direction of the screen S in step S310 (S350). For example, the virtual point VP may be moved back from the seventh position P7 to the sixth position P6.

In sum, according to the third embodiment, the electronic device 100 may move the screen S by the first distance D1 according to the first touch stroke TS1, and even when the first touch stroke TS1 ends, may keep moving the screen S, and according to whether the second touch stroke TS2 is input through the second region R2 and/or whether the relationship between the touch strokes TS1 and TS2 meets the predetermined condition, may selectively continue to move the screen S by the third distance D3 according to the second touch stroke TS2 or return the screen S to a position corresponding to the first touch stroke TS1.

By doing so, even when the user does not continue to perform the touch input on the display unit 151 at a bent portion of the display unit 151 when the display unit 151 is in the bending state, the screen S which is being moved by the first touch stroke input through the first region may be continuously displayed even after the first touch strokes ends, and according to whether the second touch stroke is input through the second region and/or whether the relationship between the first and second touch strokes satisfies the predetermined condition, the screen S may be selectively moved further to a position corresponding to the second touch stroke or back to a position corresponding to the end point of the first touch stroke, thereby providing the user with more smooth visual feedback.

### Fourth Embodiment

Hereinafter, a fourth embodiment of the present invention is described in greater detail.

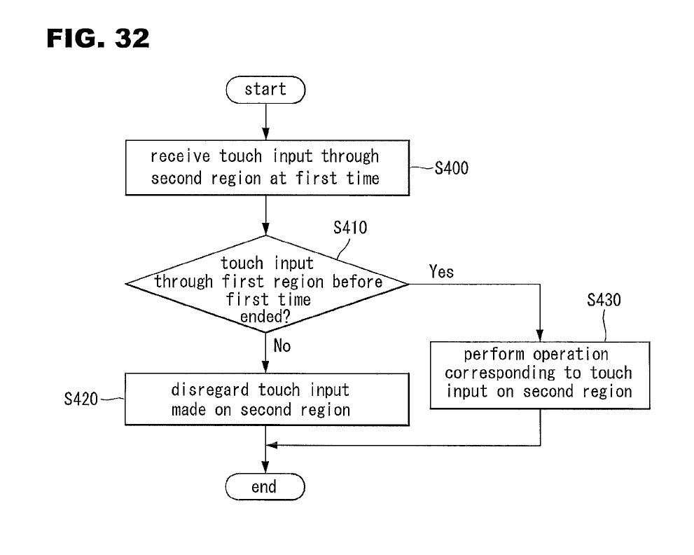

FIG. 32 is a flowchart illustrating a method of controlling an electronic device according to the fourth embodiment. Referring to FIG. 32, the control method includes a step of receiving a touch input through the second region of the display unit 151 at a first time (S400), a step of determining whether a touch input through the first region before the first time has been ended (S410), a step of, when it is determined in step S410 that the touch input through the first region has been ended, performing an operation corresponding to the touch input through the second region (S430), and a step of, when it is determined in step S410 that the touch input through the first region has not been ended until the touch is input through the second region, disregarding the touch input through the second region (S420).

Before describing each step specifically, an environment and/or circumstance where the fourth embodiment may apply is described.

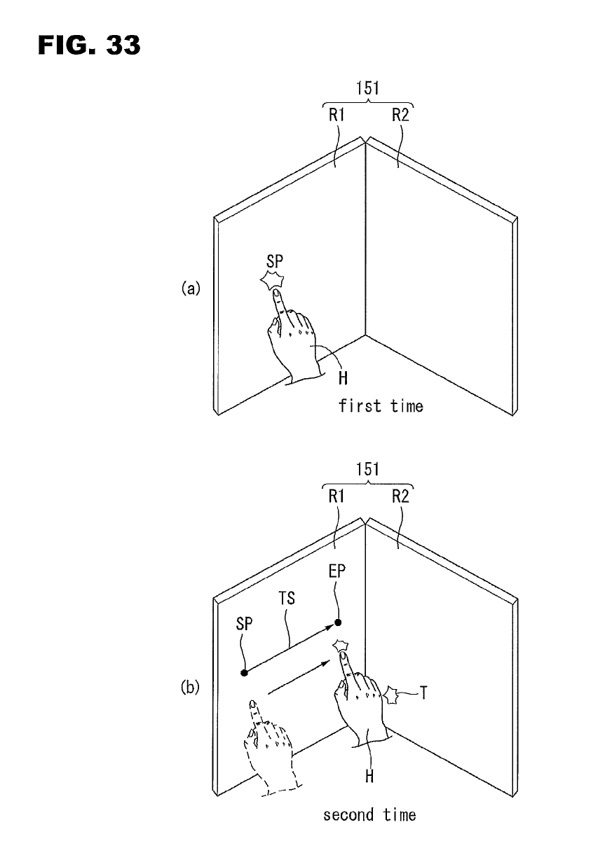

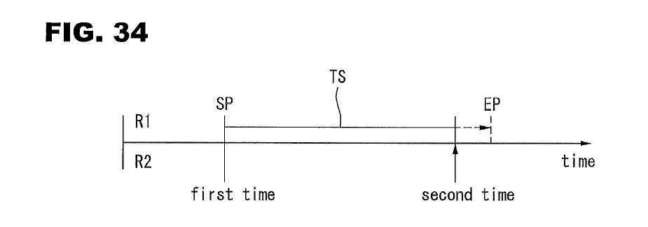

FIGS. 33 and 34 illustrate a method of controlling an electronic device according to the fourth embodiment. Referring to FIGS. 33 and 34, in the case that the display unit 151 is in the bending state, when the user attempts to input a touch stroke TS through the first region R1 using part of his hand H (for example, his index finger), as shown in (a) of FIG. 33, the user starts the touch input at the start point SP of the touch stroke TS at a first time, and as shown in (b) of FIG. 33, continues the touch stroke TS toward the end point EP of the touch stroke TS. In the process (that is, the touch stroke TS through the first region is not yet complete), another touch input T may be made through the second region R2 of the display unit 151 at a second time. The touch input through the second region R2 may be made through a portion (e.g., a little finger) of the hand H other than the portion (e.g., the user's index finger) of the hand H which has contacted the first region R1 for the touch input on the first region R1. Under this situation, the user may unintentionally end up making a touch input on the second region R2 although his original intention is to make a touch stroke TS only on the first region R1. The fourth embodiment may be provided to address any similar situations. However, the fourth embodiment is not limited as applying to such situation.

Each step of the fourth embodiment is now described specifically.

The electronic device 100 may receive a touch input through the second region R2 of the display unit 151 at the second time (S400).

The electronic device 100 may determine whether the touch stroke TS input on the first region R1 before the second time has been ended (S410). For example, if the start point SP of the touch stroke TS input on the first region R1 was detected at the first time but the end point EP of the touch stroke TS was not detected at the second time (which is later than the first time), the electronic device 100 may determine that the touch stroke has not been ended yet.

For instance, if the electronic device 100 determines that at the second time part of the user's hand H maintains contact with the first region R1 or remains in the critical distance of the proximity sensor 142 from the first region R1, the electronic device 100 may determine that the touch stroke TS input on the first region R1 has not been ended yet.

If it is determined in step S410 that the touch stroke TS input on the first region R1 has been ended, the electronic device 100 may perform an operation corresponding to the touch input T input on the second region R2 (S430). The electronic device 100 may perform the operation corresponding to the touch input T separately from the touch stroke TS input on the first region TS1.

On the contrary, if it is determined in step S410 that the touch stroke TS input on the first region R1 has not been ended until the touch input T is received through the second region R2, the electronic device 100 may disregard the touch input T input on the second region R2 (S420). Although not shown, if the touch stroke TS input on the first region R1 is ended, the electronic device 100 may perform only an operation corresponding to the touch stroke TS input on the first region R1.

By doing so, when the user desired to input a touch stroke only on the first region but unintentionally ended up making a touch input on the second region as well, the electronic device 100 may determine whether the touch input on the second region does not conform to the user's intention. If the determination result shows that the touch input on the second region is not his intention, the electronic device 100 may perform only an operation corresponding to the touch stroke input on the first region while disregarding the touch input on the second region. Accordingly, when touch input is made on the display which is in the bending state, more user convenience can be achieved.

### Fifth Embodiment

Hereinafter, a fifth embodiment of the present invention is described in greater detail.

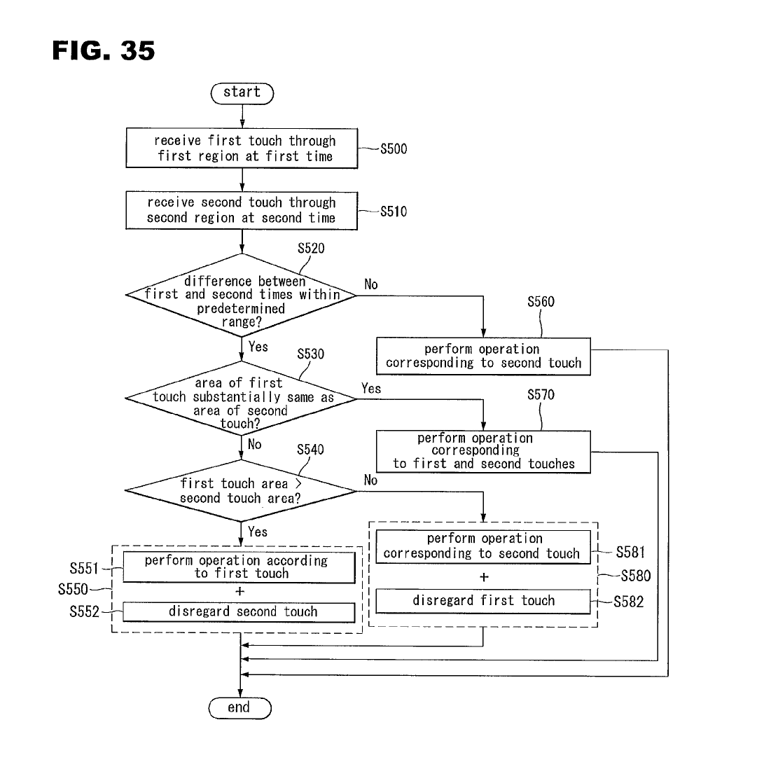

FIG. 35 is a flowchart illustrating a method of controlling an electronic device according to the fifth embodiment. Referring to FIG. 35, the control method includes a step of receiving a first touch input through the first region at a first time (S500), a step of receiving a second touch input through the second region at a second time (which is later than the first time) (S510), and a step of determining whether a difference between the first and second times is within a predetermined time range (S520).

If it is determined in step S520 that the difference between the first and second times is not within the predetermined time range, the control method may further include a step of performing an operation corresponding to the second touch input (S560). According to an embodiment, even when the difference between the first and second times is not within the predetermined time range, an operation corresponding to the first touch input may be performed. If it is determined in step S520 that the difference between the first and second times is within the predetermined time range, the control method may further include a step of determining whether the area of the first touch input is substantially the same as the area of the second touch input (S530).

If it is determined in step S530 that the area of the first touch input is substantially the same as the area of the second touch input, the control method may further include a step of performing operations corresponding the first and second touch inputs (S570), and if it is determined in step S530 that the area of the first touch input is not substantially the same as the area of the second touch input, the control method may further include a step of determining whether the area of the second touch input is larger than the area of the first touch input (S540). Step S570 may be performed by an algorithm which recognizes a multi touch and conducts an operation corresponding to the multi touch.

If it is determined in step S540 that the area of the second touch is larger than the area of the first touch input, step S550 is performed, and otherwise, step S580 is performed. Step S550 includes a step of performing an operation corresponding to the first touch input (S551) and a step of disregarding the second touch input (S552), and step S580 includes a step of performing an operation corresponding to the second touch input (S581) and a step of disregarding the first touch input (S582).

Before describing each step more specifically, an environment and/or situation where the fifth embodiment may apply is described.

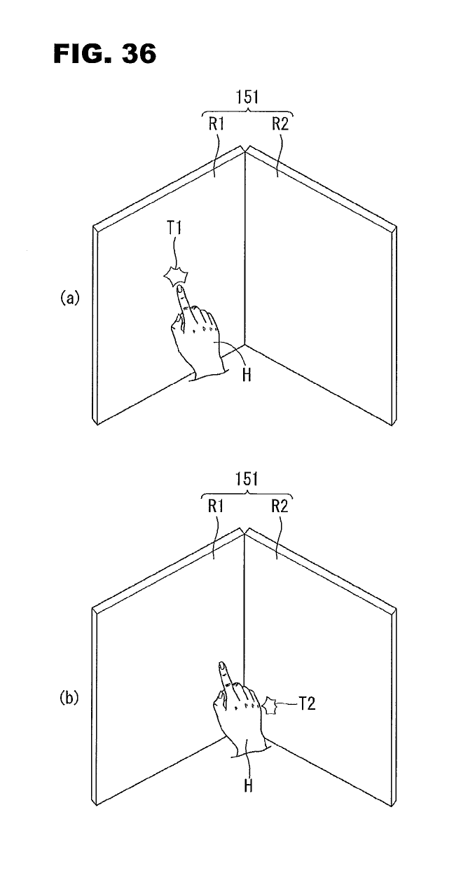

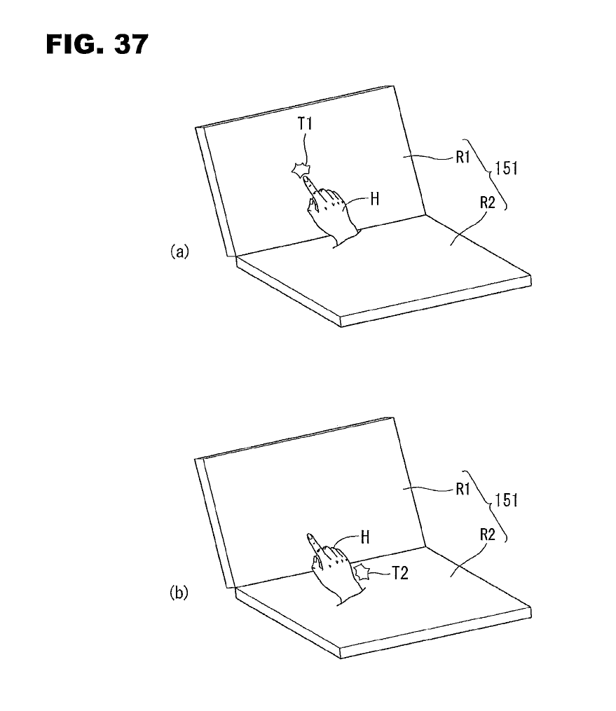

FIGS. 36 and 37 are views for describing an environment and/or situation where the control method according to the fifth embodiment may apply.

Referring to FIG. 36, the display unit 151 which is in the bending state stands substantially perpendicular to the horizontal surface. The user makes a first touch input T1 on the first region R1 using part of his hand H (e.g., an index finger) while another portion of the hand H (for example, the little finger when the user makes a fist) contacts the second region R2 or positioned within the critical distance from the second region R2, so that a second touch input T2 is made through the second region R2 without the user intending to do so.

FIG. 37 illustrates that the first region R1 of the display unit 151 which is in the bending state is inclined with respect to the horizontal surface and the second region R2 is parallel with the horizontal surface. When the user makes the first touch input T1 on the first region R1 using part of his hand H (e.g., his index finger), another portion of the hand H (e.g., the other fingers and palm of the hand H when the user makes a fist) contacts the second region R2 or is positioned within the critical distance from the second region R2, so that the second touch input T2 may be made through the second region R2 without the user's intention.

As such, in the case that the display unit 151 is bent, when the user attempts to make a touch input on one of the regions, the user may unintentionally make a touch input on the other region. To address this problem, the control method according to the fifth embodiment may be provided. However, the embodiments of the present invention are not limited as addressing the aforementioned problems.

Each step of the control method according to the fifth embodiment is now described more specifically.

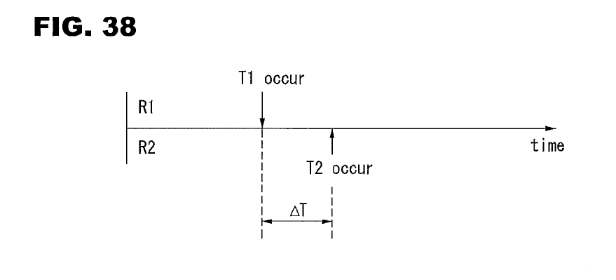

FIGS. 38 to 42 illustrate a method of controlling an electronic device according to the fifth embodiment.

The electronic device 100 may receive a first touch input T1 through the first region R1 at a first time (S500). Subsequently, the electronic device 100 may receive a second touch input T2 through the second region R2 at a second time which is later than the first time (S510). As described above, the first touch input T1 and the second touch input T2 each include a contact touch and a proximity touch.

The electronic device 100 may determine whether a difference between the first and second times is within a predetermined time range (S520). The first and second touch inputs T1 and T2 may be made with a given time gap Tg therebetween as shown in FIG. 38. The electronic device 100 measures the time gap Tg and determines whether the time gap belongs to the predetermined time range. The predetermined time range may be, e.g., 0.5 seconds. The electronic device 100 may determine whether the second touch input T2 is made through the second region R2 within a relatively short time after the first touch input T1 has been made through the first region R1.

If it is determined in step S520 that the time gap is not within the predetermined time range, the electronic device 100 may perform an operation corresponding to the second touch input T2 (S560). Alternatively, the electronic device 100 may perform an operation corresponding to the first touch input T1. For example, the electronic device 100 may independently perform the operation corresponding to the first touch input T1 and the operation corresponding to the second touch input T2. If it is determined in step S520 that the time gap is within the predetermined time range, the electronic device 100 may determine whether the first and second touch inputs T1 and T2 are identical in area to each other (S530). In other words, if it is determined in step S520 that the second touch input T2 is made within a relatively short time after the first touch input T1 has been made, the electronic device 100 may perform step S530 to determine whether both the first and second touch inputs T1 and T2 have been intended by the user.

Step S530 may be performed by determining whether a difference in area between the first and second touch inputs T1 and T2 belongs to a predetermined reference range.

If it is determined in step S530 that the first and second touch inputs T1 and T2 are equal to each other in area, the electronic device 100 may perform operations corresponding to the first and second touch inputs T1 and T2 (S570). The electronic device 100 may perform step S570 based on an algorithm which recognizes a multi touch by the first and second touch inputs T1 and T2 and performs an operation corresponding to the multi touch. The electronic device 100 may determine that both the first and second touch inputs T1 and T2 have been made under the user's intention and may perform operations corresponding to both the first and second touch inputs T1 and T2.

If it is determined in step S530 that the first and second touch inputs T1 and T2 are substantially different in area from each other, the electronic device 100 may determine whether the area of the second touch input T2 is larger than the area of the first touch input T1 (S540). The electronic device 100 may determine that one of the first and second touch inputs T1 and T2 is not intended by the user and may compare the area of the first touch input T1 with the area of the second touch input T2 to determine which one of the inputs T1 and T2 is intended by the user.

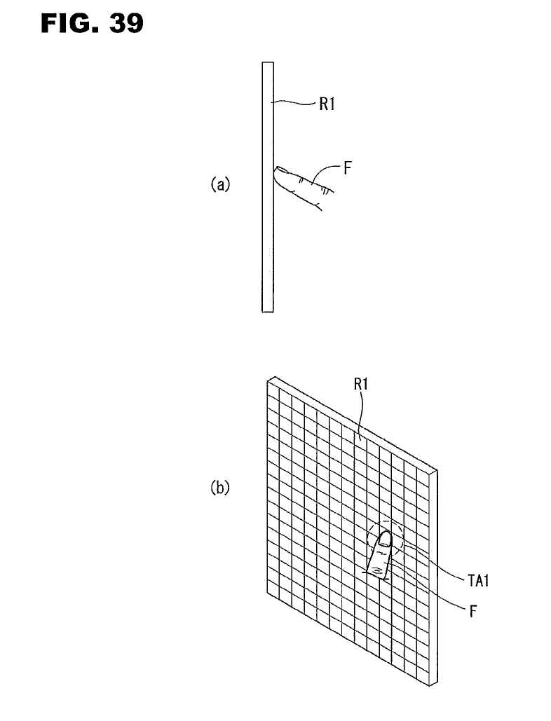

This is not described in greater detail with reference to FIGS. 39 to 42, which illustrate an example where the first touch input T1 input through the first region R1 is intended by the user while the second touch input T2 input through the second region R1 is not.

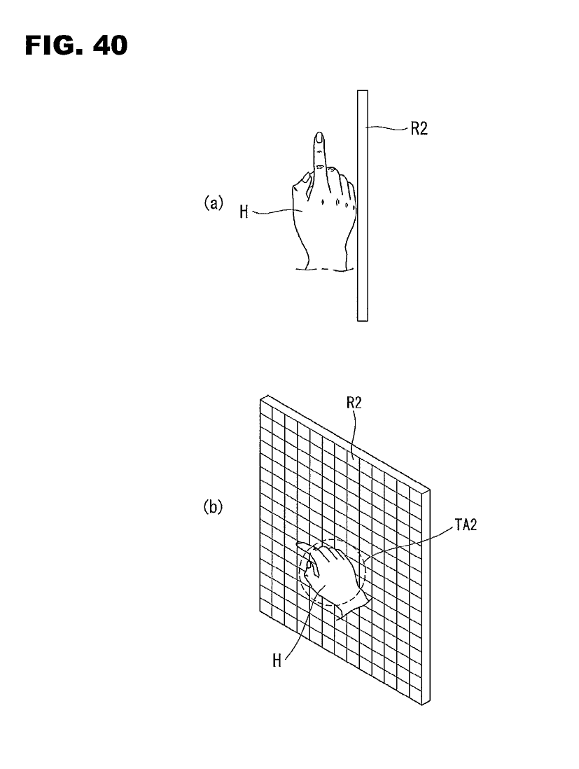

(a) of FIG. 39 illustrates in side view that the user's finger F contacts the first region R1. (b) of FIG. 39 illustrates in front view that the first region R1 is touched as shown in (a) of FIG. 39. (a) of FIG. 40 illustrates in side view that a side of the user's hand H contacts the second region R2. (b) of FIG. 40 illustrates in front view that the second region R2 is touched as shown in (a) of FIG. 39.

As shown in (b) of FIG. 39, when the finger F touches the first region R1, the area of the first touch input T1 by the finger F is represented as a first touch area TA1. As shown in (b) of FIG. 40, when the side of the hand H touches the second region R2, the area of the second touch input T2 by the side of the hand H is represented as a second touch area TA2.

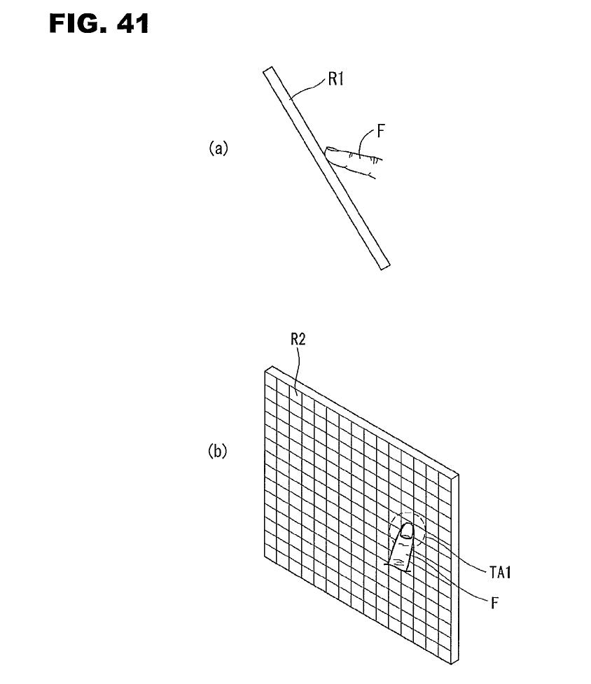

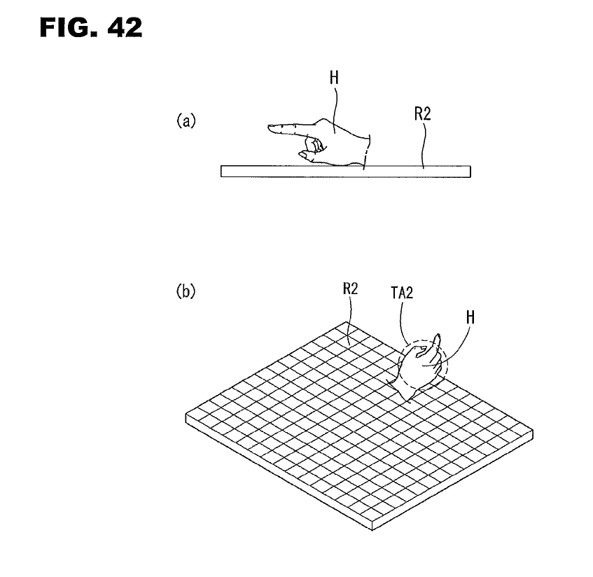

(a) of FIG. 41 illustrates in side view that the user's finger F contacts the first region R1. (b) of FIG. 41 illustrates in front view that the first region R1 is touched as shown in (a) of FIG. 41. (a) of FIG. 42 illustrates in side view that the palm of the user's hand H contacts the second region R2. (b) of FIG. 42 illustrates in front view that the second region R2 is touched as shown in (a) of FIG. 42.

As shown in (b) of FIG. 41, when the finger F touches the first region R1, the area of the first touch input T1 by the finger F is represented as the first touch area TA1. As shown in (b) of FIG. 42, when the palm of the hand H touches the second region R2, the area of the second touch input T2 by the palm of the hand H is represented as the second touch area TA2.

As such, when the user makes a touch input on one region, the area of the touch input on the region may be even smaller than the area of the touch input that has been unintentionally made on the other region. As shown in FIGS. 39 to 42, when the user makes a touch using his finger F, the touch area TA1 of the first touch input T1 made by the finger F may be smaller than the touch area TA2 of the second touch input T2 that is made by part of the user's hand H (e.g., side or palm of the hand).

Accordingly, the electronic device 100 may determine which one is intended by the user between the two touch inputs T1 and T2 by comparing the area of the first touch input T1 with the area of the second touch input T2.

When it is determined in step S540 that the area of the second touch input T2 is larger than the area of the first touch input T1, the electronic device 100 may determine that the first touch input T1 is the one intended by the user and may perform step S550 which includes step S551 of performing an operation corresponding to the first touch input T1 and step S550 of disregarding the second touch input T2.

On the contrary, when it is determined in step S540 that the area of the second touch input T2 is smaller than the area of the first touch input T1, the electronic device 100 may determine that the second touch input T2 is the one intended by the user and may perform step S580 which includes step S581 of performing an operation corresponding to the second touch input T2 and step S582 of disregarding the first touch input T1.

By doing so, even when the user attempted to input a touch only on the first region but an unintentional touch input is made on the second region as well, the electronic device 100 may determine whether the touch input made on the second region is intended by the user. When it is determined that the touch input made on the second region is unintentional, the electronic device 100 may perform only an operation corresponding to the touch stroke input on the first region while disregarding the touch input made on the second region. Accordingly, when a touch input is made on the display unit 151 which is in the bending state, further user convenience may be achieved.

### Sixth Embodiment

Hereinafter, a sixth embodiment of the present invention is described in greater detail.

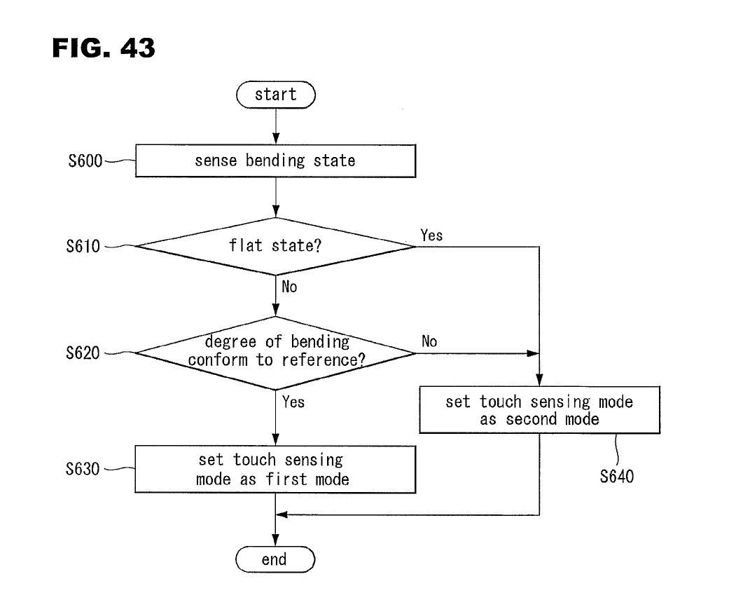

FIG. 43 is a flowchart illustrating a method of controlling an electronic device according to the sixth embodiment. Referring to FIG. 43, the control method includes a step of sensing a bending state of the display unit 151 (S600) and a step of determining whether the display unit 151 is in the flat state (S610). If it is determined in step S610 that the display unit 151 is in the flat state, the control method may further include a step of setting the touch sensing mode of the display unit 151 as a second mode (S640), and if it is determined in step S610 that the display unit 151 is not in the flat state, the control method may further include a step of determining whether the degree of bending of the display unit 151 conforms to a predetermined reference (S620). If it is determined in step S620 that the degree of bending of the display unit 151 does not conform to the predetermined reference, step S640 may be performed, but if it is determined in step S620 that the degree of bending of the display unit 151 conforms to the predetermined reference, a step of setting the touch sensing mode of the display unit 151 as a first mode (S630) may be performed.

The above-described first to fifth embodiments are suggested to address the problems that may occur when the display unit 151 is in the bending state. Accordingly, the first to fifth embodiments may not apply a lot where the display unit 151 is in the flat state. As a consequence, in the case that the display unit 151 is bendable, the algorithm which analyzes touch inputs and performs operations corresponding to the touch inputs when the display unit 151 is in the flat state needs to be set differently from the algorithm which analyzes touch inputs and performs operation corresponding to the touch inputs when the display unit 151 is in the bending state. For ease of description, the algorithm which applies to analyze touch inputs when the display unit 151 is in the bending state is referred to as a “first touch algorithm”, and the algorithm which applies to analyze touch inputs when the display unit 151 is in the flat state is referred to as a “second touch algorithm”. The first touch algorithm needs to be designed different from the second touch algorithm.

The second touch algorithm is the same or similar to a touch algorithm that applies to smartphones, laptop computers, tablet PCs, or the like.

The first touch algorithm may include a touch algorithm implemented by a combination of any one or more of the first to fifth embodiments.

Hereinafter, when the first touch algorithm applies, it can be represented as the phrase “touch sensing mode is set as the first mode,” and when the second touch algorithm applies, it can be represented as the phrase “touch sensing mode is set as the second mode.”

Accordingly, the control method according to the sixth embodiment may continuously monitor whether the display unit 151 is in the bending state or flat state (S600). Further, the electronic device 100 may determine whether the display unit 151 is in the flat state while continuously performing step S600 (S610).

In performing step S600 and/or step S610, the electronic device 100 may determine whether the display unit 151 is in the bending state based on values output from the bending sensor. For example, the electronic device 100 may determine whether the display unit 151 is in the bending or flat state based on values output from the bending sensor. When the display unit 151 changes its state, the electronic device 100 may determine the time, position, and degree of bending when the change of the state occurs.

If it is determined in step S610 that the display unit 151 is in the flat state, the electronic device 100 may set the touch sensing mode of the electronic device 100 as the second mode (S640).

If it is determined in step S610 that the display unit 151 is not in the flat state, the display unit 151 may determine whether the degree of bending of the display unit 151 conforms to a predetermined reference (S620).

The predetermined reference for the degree of bending may be set as an angle between the first and second regions R1 and R2. For instance, the predetermined reference may be set to be 80° or more and 160° or less. If the predetermined reference is set as described above, when an angle between the first and second regions R1 and R2 is 120°, the degree of bending of the display unit 151 is determined to conform to the predetermined reference, and when the angle between the first and second regions R1 and R2 is 170°, the degree of bending of the display unit 151 is determined not to conform to the predetermined reference. The predetermined reference is not limited thereto, and any other references may be employed depending on design.

If it is determined in step S620 that the degree of bending of the display unit 151 does not conform to the predetermined reference, the electronic device 100 may set the touch sensing mode as the second mode (S640).

However, if it is determined in step S620 that the degree of bending of the display unit 151 conforms to the predetermined reference, the electronic device 100 may set the touch sensing mode as the first mode (S630).

As described above, the first touch algorithm may include a touch algorithm implemented by a combination of any one or more of the first to fifth embodiments. Accordingly, in the case that the electronic device 100, which has been monitoring the bending state of the display unit 151, determines that the display unit 151 turns into the bending state and the degree of bending of the display unit 151 conforms to the predetermined reference, the electronic device 100 may analyze one or more touch inputs that are made on the display unit 151 depending on a method implemented as a combination of any one or more of the first to fifth embodiments.

For example, in the case that according to the sixth embodiment the display unit 151 is in the bending state and the degree of bending conforms to the predetermined reference, when the first touch stroke TS1 is input on the first region R1 and the second touch stroke TS2 is input on the second region R2 as described in the first embodiment, the electronic device 100 may determine whether a relationship between the first and second touch strokes TS1 and TS2 conforms to a predetermined condition, and if yes, may perform operations corresponding to the first and second touch strokes TS1 and TS2. However, if the display unit 151 is in the flat state, the electronic device 100 may perform one operation corresponding to the first touch stroke TS1 and may perform another operation corresponding to the second touch stroke TS2.

If the angle between the first and second regions R1 and R2 is too small, it may be difficult for the user to make a touch input on one of the regions in the display unit 151. Under such situation, it may be unnecessary to change the touch sensing mode into the first mode. When the angle between the regions R1 and R2 approaches nearly 180 degrees or exceeds 180 degrees, the touch algorithm according to the first to fifth embodiments may be not needed. For these reasons, it needs to be determined whether the degree of bending of the display unit 151 conforms to the predetermined reference.

When the display unit 151 is in the flat state and/or the degree of bending of the display unit 151 does not conform to the predetermined reference, the electronic device 100 analyzes touch inputs by existing methods but if the degree of bending of the display unit 151 conforms to the predetermined reference, the display unit 151 analyzes touch inputs based on a touch algorithm implemented by a combination of at least one or more of the first to fifth embodiments suggested to address the problems that may occur upon touch input when the display unit 151 is in the bending state. Thus, when the display unit 151 is in the flat state, the electronic device 100 may allow the user to perform touch input according to existing methods. Further, when the display unit 151 is in the bending state, the electronic device 100 may allow the user to have a further improved touch interface.

In the method of controlling an electronic device according to the present invention, each step in each embodiment is not inevitable, and each embodiment may selectively include the steps therein. The steps in each embodiment are not necessarily performed in the order described above, and for example, a later step may be performed earlier than an earlier step.

The control method may be stored in a computer readable recording medium in the form of a code or program.

The invention has been explained above with reference to exemplary embodiments. It will be evident to those skilled in the art that various modifications may be made thereto without departing from the broader spirit and scope of the invention. Further, although the invention has been described in the context its implementation in particular environments and for particular applications, those skilled in the art will recognize that the present invention's usefulness is not limited thereto and that the invention can be beneficially utilized in any number of environments and implementations. The foregoing description and drawings are, accordingly, to be regarded in an illustrative rather than a restrictive sense.

What is claimed is:

1. An electronic device comprising:
a display unit including a first region and a second region; and
a control unit configured to receive a first touch stroke through the first region, to receive a second touch stroke through the second region, to generate a third touch stroke corresponding to the first and second touch strokes when a relationship between the first and second touch strokes satisfies to a predetermined condition, and to perform an operation corresponding to the third touch stroke.

2. The electronic device of claim 1, wherein the predetermined condition is whether a difference between an end time of the first touch stroke and a start time of the second touch stroke is within a predetermined time range.

3. The electronic device of claim 1, wherein the predetermined condition is whether a difference between a trace direction of the first touch stroke and a trace direction of the second touch stroke is within a predetermined range.

4. The electronic device of claim 3, wherein the predetermined range varies depending on the trace direction of the first touch stroke.

5. The electronic device of claim 1, wherein the predetermined condition is whether a start point of the second touch stroke is within a range determined by an end point of the first touch stroke.

6. The electronic device of claim 1, wherein the predetermined condition is whether a difference in speed between the first and second touch strokes is within a predetermined range.

7. The electronic device of claim 6, wherein a speed of the second touch stroke is a speed obtained when the second touch stroke is positioned near a start point of the second touch stroke.

8. The electronic device of claim 1, wherein the predetermined condition is whether a variation in distance of a touching body with respect to the display unit is within a predetermined range, the variation being measured at a least one of an end point of the first touch stroke and a start point of the second touch stroke.

9. The electronic device of claim 1, wherein the control unit is configured to generate the third touch stroke so that a start point of the third touch stroke is a start point of the first touch stroke and an end point of the third touch stroke is an end point of the second touch stroke.

10. The electronic device of claim 1, wherein the display unit is a touch screen.

11. The electronic device of claim 1, wherein the display unit is divided into at least two regions including the first and second regions by bending.

12. An electronic device comprising:
a display unit including at least two regions including first and second regions; and
a control unit configured to change a position of an object from a first position and a second position according to a first touch stroke input through the first region, to change the position of the object from the second position to a third position after the first touch stroke ends, to receive a second touch stroke through the second region, to determine whether the second touch stroke satisfies a predetermined condition, and when the second touch stroke satisfies the predetermined condition, to change the position of the object from the third position to a fourth position.

13. The electronic device of claim 12, wherein when the second touch stroke does not satisfy the predetermined condition, the control unit is configured to change the position of the object from the third position to the second position.

14. The electronic device of claim 12, wherein the second position is determined by the first touch stroke.

15. The electronic device of claim 12, wherein the fourth position is determined by the second touch stroke.

16. An electronic device comprising:
a display unit including at least two regions including first and second regions; and
a control unit configured to move a screen image displayed on the display unit according to a first touch stroke input through the first region by a first distance, to move the screen image by a second distance after the first touch stroke ends, to receive a second touch stroke through the second region, to determine whether the second touch stroke satisfies a predetermined condition, and when the second touch stroke satisfies the predetermined condition, to move the screen image by a third distance.

17. The electronic device of claim 16, wherein when the second touch stroke does not satisfy the predetermined condition, the control unit is configured to move the screen image by the second distance in an opposite direction of a travelling direction in which the screen image travels according to the first touch stroke.

18. The electronic device of claim 16, wherein the first distance is determined by the first touch stroke.

19. The electronic device of claim 16, wherein the third distance is determined by the second touch stroke.

20. An electronic device comprising:
a display unit including at least two regions including first and second regions; and
a control unit configured to perform an operation corresponding to a first touch stroke input through the first region and to disregard a touch input made through the second region while receiving a touch stroke through the first region.

21. The electronic device of claim 20, wherein the display unit is divided into the at least two regions including the first and second regions by a bending operation.

22. The electronic device of claim 21, wherein the control unit is configured to perform an operation corresponding to the touch stroke when the touch stroke through the first region ends.

23. An electronic device comprising:
a display unit including at least two regions including first and second regions; and
a control unit configured to receive a first touch input through the first region, to receive a second touch input through the second region, to determine whether a difference between a first time when the first touch input is made and a first time when the second touch input is made is within a predetermined time range, and when the difference between the first time when the first touch input is made and the first time when the second touch input is made is within the predetermined time range, to select one of the first and second touch inputs, wherein the selected touch input has a smaller area than an area of the other touch input, and to perform an operation corresponding to the selected touch input.

24. The electronic device of claim 23, wherein the control unit is configured to disregard the other touch input(s) than the selected touch input.

25. The electronic device of claim 23, wherein when the difference between the first time when the first touch input is made and the first time when the second touch input is made is not within the predetermined time range, the control unit is configured to perform a first operation corresponding to the first touch input and a second operation corresponding to the second touch input.

26. An electronic device comprising:
a display unit including a state including a bending state and a flat state depending on a degree of bending, wherein when in the bending state, the display unit includes at least two regions including first and second regions; and
a control unit configured to select one of first and second modes depending on the state of the display unit and to analyze a touch stroke input through the display unit depending on the selected mode, wherein in a case where two different first and second touch strokes are input, the control unit is configured to perform an operation corresponding to a combination of the two touch strokes when the first mode is selected and to perform two operations respectively corresponding to the two touch strokes when the second mode is selected.

27. The electronic device of claim 26, wherein the control unit is configured to select the first mode, to determine whether a relationship between the two touch strokes satisfies a predetermined condition, and when the relationship satisfies the predetermined condition, to perform an operation corresponding to a combination of the two touch strokes.
